(19) United States
(12) Patent Application Publication
(10) Pub. No.: US 2006/0217925 A1
(43) Pub. Date: Sep. 28, 2006

(54) Methods for entity identification

(76) Inventors: Maxime Georges Taron, Paris (FR); Nikolaos Paragios, Vincennes (FR); Marie-Pierre Jolly, Hillsborough, NJ (US)

Correspondence Address: Siemens Corporation;Intellectual Property Department, 170 Wood Avenue South, Iselin, NJ, 08830, US

(21) Appl. No.: 11/366,236

(22) Filed: Mar. 2, 2006

Related U.S. Application Data
(60) Provisional application No. 60/664,503, filed on Mar. 23, 2005.

(51) Int. Cl. G06F 17/18

(52) U.S. Cl. 702/179

(57) ABSTRACT

Certain exemplary embodiments comprise a method, which can comprise automatically determining a probability that an entity belongs to a representation set. The representation set can be associated with a set of vectors of parameters and associated covariance matrices. Each covariance matrix can be associated with uncertainties of values comprised in the vector of parameters.

### CROSS-REFERENCE TO RELATED APPLICATIONS

This application claims priority to pending U.S. Provisional Patent Application Ser. No. 60/664,503 (2005P05174US01 (1009-155)), filed 23 Mar. 2005.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is an exemplary set of entities comprised by a group;

FIG. 2 is an exemplary set of entities that might not be identifiable as members of an exemplary group;

FIG. 3 is a projection of the covariance matrix Σ_{Θ} on grid points;

FIG. 4 is an exemplary graph illustrating is a distribution of the digits 3 and 4 in the space of likelihoods of belonging to the classes “3” and “4”;

FIG. 5 is an exemplary graph illustrating a distribution of the digits 3 and 9 in the space of likelihoods of belonging to the classes “3” and “9”;

FIG. 6 is an exemplary graph illustrating is a distribution of the digits 4 and 9 in the space of likelihoods of belonging to the classes “4” and “9”;

FIG. 7 is a diagram illustrating that digits 4 and 9 can be very similar;

FIG. 8A is an exemplary drawing illustrating the registration process in an initial state;

FIG. 8B is an exemplary drawing illustrating the registration process after registration of the training samples to the model with respect to an affine transform;

FIG. 8C is an exemplary drawing illustrating the registration process after free form deformation of the model to warp to the training samples;

FIG. 9A, FIG. 9B, FIG. 10A, and FIG. 10B illustrate the density probability estimation as a surface in a 3D space;

FIG. 11 shows examples of FFD deformations along with uncertainty ellipses;

FIG. 12 shows an exemplary histogram of a typical image of the corpus callosum;

FIG. 13A illustrates a segmentation with uncertainties estimates of the corpus callosum comprising automatic rough positioning of the model;

FIG. 13B illustrates a segmentation with uncertainties estimates of the corpus callosum comprising segmentation through affine transformation of the model;

FIG. 13C illustrates a segmentation using the local deformation of the FFD grid and uncertainties estimates on the registration/segmentation process;

FIG. 14 illustrates an exemplary embodiment of segmentation results with uncertainty measures;

FIG. 15 is a block diagram of an exemplary embodiment of a system 15000;

FIG. 16 is a flowchart of an exemplary embodiment of a method 16000; and

FIG. 17 is a block diagram of an exemplary embodiment of an information device 17000.

### DEFINITIONS

When the following terms are used substantively herein, the accompanying definitions apply:

a—at least one.

activity—an action, act, step, and/or process or portion thereof.

adapted to—made suitable or fit for a specific use or situation.

affine transformation—a set of translation, rotation, and/or scaling operations in two spatial directions of a plane. Affine transformations allow entity representations with different scales, orientations, and origins to be coregistered.

and/or—either in conjunction with or in alternative to.

apparatus—an appliance or device for a particular purpose.

approximately—nearly the same as.

arbitrarily small positive parameter—a selected non-zero value characterized by a relatively low magnitude of less than approximately 10⁻⁵.

associated with—related to.

attempt—to try to achieve.

attempts—one or more efforts or tries.

automatically—acting or operating in a manner essentially independent of external influence or control. For example, an automatic light switch can turn on upon “seeing” a person in its view, without the person manually operating the light switch.

belongs—fits into a set.

can—is capable of, in at least some embodiments.

comprising—including but not limited to.

configured to—capable of performing a particular function.

constrain—to restrain within bounds.

coordinate—one or more values used to determine the position of a point, line, curve, or plane in a space of a given dimension with respect to a system of lines or other fixed references.

correspondences—one or more relationships between one or more related values.

count—a defined quantity.

covariance matrix—an ordered plurality of values associated with uncertainties of values comprised in a model of an entity such as values comprised in a vector of parameters.

cubic B-spline—a smooth curve comprising segments characterized by third order polynomial coefficients depending on a one or more control points.

data—distinct pieces of information, usually formatted in a special or predetermined way and/or organized to express concepts.

define—to establish the outline, form, or structure of.

describe—to represent.

details—particulars considered individually and in relation to a whole.

determine—to ascertain, obtain, and/or calculate.

device—a machine, manufacture, and/or collection thereof.

dimensionality—a number of independent coordinates configured to specify points in a space.

direction—a distance independent relationship between two points in space that specifies the position of either with respect to the other; the relationship by which the alignment or orientation of any position with respect to any other position is established.

distance map—a plurality of values representative of a separation of each of a predetermined plurality of points of an entity with respect to one or more defined references, points, lines, curves, planes, surfaces, and/or entities, etc.

domain—a set of all possible values of an independent variable of a function.

energy function—a mathematical representation of a closeness of fit of an entity to a model.

energy minimization—an attempt to reduce a magnitude of an objective function associated with a model of an entity.

entity—something that exists as a particular and discrete unit.

Euclidean distance transform—one or more mathematical operations configured to convert a binary digital image, comprising feature and non-feature pixels, into an image where all non-feature pixels have a value corresponding to a distance, computed as a straight line distance, to a nearest feature pixel.

exemplary—serving as a model.

free form deformation—mapping a first representation of an entity to a second representation, wherein each point in the first representation corresponds to the second representation.

haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.

hybrid estimator—a mathematical function configured to calculate a probability, the mathematical function comprising a weighted summation of a selected subset of kernels.

identity matrix—a square array of numeric or algebraic quantities characterized by values of unity along a diagonal of the array defined by an element in a first row and a first column, the array characterized by zero values for each of the values not along the diagonal.

image—an at least two-dimensional representation of an entity and/or phenomenon.

indexed element—one of a series of values referenced by a moniker that serves to uniquely identify a particular value.

indicative—serving to indicate.

information device—any device capable of processing information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.

input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.

isosurface—a surface having a constant value for a first variable within a volume defined by three or more variables comprising the first variable.

iterative suboptimal algorithm—a repetitive method configured to change a value of an objective function to a good level, the good level not necessarily a best level.

iteratively—repeatedly.

kernel—a transition function of a (usually discrete) stochastic process. Often, it is assumed to be independent and identically distributed, and thus a probability density function.

likely—statistically determined to be suitable.

log likelihood—a method for testing nested hypotheses associated with calculating a likelihood of observing actual data, given a specific model.

machine instructions—directions adapted to cause a machine, such as an information device, to perform a particular operation or function.

machine readable medium—a physical structure from which a machine can obtain data and/or information. Examples include a memory, punch cards, etc.

magnitude—size or extent.

match—to determine a correspondence between two or more values, entities, and/or groups of entities.

mathematical gradient—a slope of a defined mathematical surface.

matrix—a rectangular array of numeric or algebraic quantities.

may—is allowed and/or permitted to, in at least some embodiments.

memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.

method—a process, procedure, and/or collection of related activities for accomplishing something.

minimized—adjusted to a lowest level.

model—a mathematical and/or schematic description of an entity and/or system.

network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.

network interface—any device, system, or subsystem capable of coupling an information device to a network. For example, a network interface can be a telephone, cellular phone, cellular modem, telephone data modem, fax modem, wireless transceiver, ethernet card, cable modem, digital subscriber line interface, bridge, hub, router, or other similar device.

normal—substantially perpendicular to a defined line and/or plane.

obtain—to receive, calculate, determine, and/or compute.

packet—a discrete instance of communication.

partially—to a degree; not totally.

particular—specific.

Parzen Window density estimation—a non-parametric method that utilizes samples drawn from an unknown distribution to model, via interpolation, a density of the unknown distribution or kernel.

plurality—the state of being plural and/or more than one.

point—an element in a geometrically described set; and/or a dimensionless geometric entity having no properties except location.

predetermined—established in advance.

principal mode—a value occurring most frequently in a probability distribution defined by a probability density function.

principle component analysis—a cluster analysis method configured to capture a variance in a set of data in terms of principle components.

principle components—a set of variables that define a projection that encapsulates a maximum amount of variation in a set of data, the projection orthogonal (i.e., uncorrelated) to a previous principle component comprised in the set of data.

probability—a quantitative expression of a likelihood of an occurrence.

probability density function—a mathematical function serving to represent a probability distribution.

probability distribution—a function whose integral over a given interval gives the probability that the values of a random variable will fall within the interval.

processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.

provide—to furnish and/or supply.

recalculate—to repeat a predetermined calculation.

receive—to take, get, acquire, and/or have bestowed upon.

reduce—to make lower in magnitude.

register—to convert a representation to a particular coordinate system.

registration transform—a mathematical operation configured to convert a representation to a particular coordinate system.

remove—to move from a place or position occupied.

render—to make perceptible to a human, for example as data, commands, text, graphics, audio, video, animation, and/or hyperlinks, etc., such as via any visual and/or audio means, such as via a display, a monitor, electric paper, an ocular implant, a speaker, a cochlear implant, etc.

repeatedly—again and again; repetitively.

representation—a mathematical characterization of an entity.

representation set—a plurality of entities sharing one or more common features and/or characterizations.

responsive—reacting to an influence and/or impetus.

scalar—a quantity that is completely specified by a magnitude and has no direction.

scaling factor—a ratio between corresponding dimensions of two entities having similar shapes.

set—a plurality of predetermined things.

shape—a characteristic surface, outline, and/or contour of an entity.

size—physical dimensions, proportions, magnitude, or extent of an entity.

statistical estimator—one or more mathematical operations configured to provide an approximately calculated value based upon determined statistics related to the value.

store—to place, hold, and/or retain data, typically in a memory.

subset—a portion of a set.

substantially—to a great extent or degree.

system—a collection of mechanisms, devices, data, and/or instructions, the collection designed to perform one or more specific functions.

tangential direction—of or related to a line which is substantially not normal to a defined plane.

topology preservation algorithm—an entity characterization algorithm that maintains geometric relationships between points describing the entity.

transformation—a conversion of a first representation of an entity to a second representation of the entity.

uncertainty—an estimated amount or percentage by which an observed or calculated value may differ from a true value.

user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.

validity—soundness.

value—an assigned or calculated numerical quantity.

vector of parameters—a plurality of values characterizing an entity in a predetermined coordinate system.

via—by way of and/or utilizing.

warp—to change and/or distort a mathematical representation of an entity.

weight factor—a value representative of an estimated importance of a calculation, entity, and/or calculated quantity.

zero—at a point of origin of a coordinate system.

### DETAILED DESCRIPTION

Certain exemplary embodiments comprise a method, which can comprise automatically determining a probability that an entity belongs to a representation set. The representation set can be associated with a vector of parameters and a covariance matrix. The covariance matrix can be associated with uncertainties of values comprised in the vector of parameters.

Exemplary embodiments described herein between paragraphs [141] and [256] are illustrative and not restrictive of other exemplary embodiments described herein.

Modeling the geometric form of entities is a challenging task of computational vision. Such a task consists of two steps, (i) registration, and (ii) statistical modeling. Certain exemplary embodiments comprise addressing registration and modeling in a sequential fashion. Within such an approach registration errors are not accounted for and often lead to incorrect and erroneous models. Certain exemplary embodiments can comprise a technique for shape modeling in a space of implicit polynomials. Registration consists of recovering an optimal one-to-one transformation of a higher order polynomial along with uncertainties measures that are determined according to the covariance matrix of the correspondences at the zero isosurface. Such measures are used to weight the importance of the training samples in the modeling phase according to a variable bandwidth non-parametric density estimation process. The selection of the most appropriate kernels do represent the training set is done through the Random Sample Consensus (RANSAC) method. Exceptional results for patterns of digits, related with the registration and the modeling aspects of certain exemplary embodiments demonstrate the potential of exemplary methods.

Domain knowledge is often available in computational vision and therefore efficient techniques can be developed to account for it. To this end, once registration of the samples (shapes, appearance, motion, etc.) to a common pose is completed, their statistical characterization according to a compact model is recovered that is used to impose constraints when solving the inference problem.

One can define the registration problem as follows: recover a transformation between a source and a target shape that results in meaningful correspondences between their basic elements. To this end, one (i) should select an appropriate representation for the structures of interest, (ii) define the set and the nature of plausible transformations, and (iii) determine an appropriate mathematical framework to recover the optimal registration parameters.

Point-based global and local registration through low cost optimization techniques like the Iterative Closest point (ICP) algorithm is the most primitive approach to shape registration while one can refer to more advanced methods like diffeomorphic matching. More advanced representations of shapes refer to B-splines as well as other form of continuous interpolation functions, shocks, skeletons and distance transforms, etc.

Registration can be either global or local. Global parametric transformations are within a restricted group, like rigid, similarity, affine, etc. The term local registration is often used in a narrower sense and refers to a transformation with infinite degrees of freedom, which can potentially map any finite number of points to the same number of points. However, non-rigid registration is often an under constrained problem where in order to find a unique non-rigid transformation, further constraints might be desired that can be introduced through a regularization of the registration field.

A different approach consists of addressing registration as a statistical estimation problem through successive steps. Within each step the uncertainty in the estimates is being computed and is used to guide further steps in the overall algorithm. Similar to that in the covariance matrix is used within an ICP algorithm to sample the correspondences so that registration is well-constrained in all directions in parameter space. In local deformation and uncertainties are simultaneously recovered for the optical flow estimation problem through a Gaussian noise assumption on the observation.

Similar to the registration problem, the modeling aspect consists of (i) selecting the nature of the density function, and (ii) recovering the parameters of such a function so it approximates the registered data. Parametric linear models like Gaussian densities are often employed through either through an EM algorithm or a singular value decomposition. One can claim that such models refer to an efficient compact approximation when the selected model fits to the data. Non-parametric approaches of fixed bandwidth kernels like Parzen windows are a more efficient technique to approximate data that do not obey a particular rule. Their tradeoff is being a computationally expensive approach while important attention is to be paid on the selection of their bandwidth.

Certain exemplary embodiments comprise a novel technique for shape modeling that exploits registration uncertainties. To this end shapes are represented in an implicit fashion and are registered using a thin-plate spline deformation model towards a topology-preservation algorithm that can provide also certain uncertainties measures according to the covariance estimation matrix at the zero iso-surface. Upon dimensionality reduction, through a Random Sample Consensus that dictates the most representative kernel set, these measures are used within a variable bandwidth kernel-based density function. Given a new example once registration and uncertainties estimation has been completed, appropriate metrics are designed that do explicitly encode the estimates and their uncertainties to evaluate the probability of the subject under consideration for being part of the family of the model.

Smoothness and in particular topology preservation are desirable properties in registration. A transformation is said to be smooth if all partial derivatives, up to certain orders, exist and are continuous while it is said to preserve the topology if the source and the transformed source have the same topology.

In the present framework, a shape S is represented in an implicit fashion using the Euclidean distance transform D. In the 2D case, we consider the function defined on the image domain Ω and R_{S} is the region enclosed by S:

$$ϕ 𝓈 ( x , y ) = \{ \begin{matrix}0 , & ( x , y ) ∈ 𝒮 \\ + 𝒟 ( ( x , y ) , 𝒮 ) , & ( x , y ) ∈ ℛ𝓈 \\ - D ( ( x , y ) , 𝒮 ) , & ( x , y ) ∈ ℛ𝓈\end{matrix}$$

Such a space is invariant to translation and rotation and can also be modified to account for scale variations. In the most general case an apparent relation between the distance function of the source and the target is not present.

Now consider a smooth diffeomorphism defined on the image domain Ω and with the vector of parameters Θ∈ [symbol] [symbol]
(Θ,.):Ω→Ω

Standard point-based curve registration consists of applying [symbol] to the source shape S and minimizing the curve integral along S such that some metric error between the transformed source and the target is minimal:
E_{O}( [symbol] (Θ))= [symbol] _{S}ρ(Θ_{T}( [symbol] (Θ, x))ds
where ρ is a robust estimator. One can extend registration within a band of information along numerous image isosurfaces:
E_{α}( [symbol] (Θ))=∫∫_{Ω}X_{α}(φS(x))ρ(φ_{S}(x)−φ_{T}( [symbol] (Θ, x)))dx
where we introduce the indicator function:

$${𝒳}_{α} ( x ) = \{ \begin{matrix}1 / ( 2 α ) & if x ∈ [ - α , α ] \\ 0 & else\end{matrix}$$

Within such a process the selection of the parameter α can be important since to some extent it refers to the scale of the shapes to be registered. On the other hand, it is natural when converging to the optimal solution that α tends to 0. Therefore, we assume a finite number of decreasing set of radii {α₀> . . . >αₜ> . . . >αₙ≈0} that is equivalent to a scale-space decomposition of the process. If Θ is too large, there is a high risk of converging to a local minimum. So, we progressively increase the complexity of the transformation and therefore the size of Θ as αₖ decreases.

Let Θₜ₋₁ be the parameters defining the transformation [symbol] ₜ₋₁= [symbol] (Θₜ₋₁,.) for which the energy was minimum at scale t−1. Also let S^{t-1}= [symbol] ₜ₋₁∘S. The registration between shapes is then equivalent to iteratively minimizing:
E_{α}_{ₜ}( [symbol] (Θ))=∫∫_{Ω}χ_{α}_{ₜ}(φ_{S}(x))ρ(φ_{S}_{^{t−1}}( [symbol] ₜ₋₁(x))−φ_{T}( [symbol] (Θ, x)))dx
where a correction process is applied when refining scales through the modification of the distance transform that describes the source shape φ_{S}_{^{t−1}}( ). Within such a formulation the integration domain is always related to the initial source shape and does not depend on the number of iteration or the parameter αₜ. Moreover when using the Euclidean distance and αₜ tends to 0, E_{α}_{ₜ}( [symbol] (Θ)) is equivalent to the point based registration (E_{α}_{_{∞}}( [symbol] (Θ))=E₀( [symbol] (Θ))).

Such an objective function can be used to address global registration as well as local deformations. We use an affine transformation (with six degrees of freedom) to represent the global transformation and a free form deformation to address the local deformations. Cubic B-spline based free form deformations are an efficient way to model locally smooth transformations on images. Deformations of shapes (and their implicit representation φ_{S}) are recovered by evolving a square control lattice P that is overlaid on the initial distance transform structure. Let us consider the control lattice points {P_{m,n}} defining the initial regular grid. The displacement of any of control point will induce a local and C² field of deformation:

$$ℒ ( Θ , x ) = {\sum }_{k = - 1}^{2} {\sum }_{l = - 1}^{2} {B}_{k} ( u ) {B}_{l} ( υ ) ( {P}_{i + k , j + l} + δ {P}_{i + k , j + l} )$$

where x=(u,v) and Bₖ is the k^{th} basis function of the cubic B-spline. This local transformation is a compromise between global and local registration and its parameters consist of the displacement of the control points (Θ={δP_{m,n}}). Such a framework is introduced using implicit functions defined on the complete domain Ω.

To recover a smooth transformation and avoid folding, we adopt a regularization term motivated by the thin plate energy functional to control the spatial variations of the displacement:
Eₛₘₒₒₜₕ( [symbol] (Θ))=∫∫_{Ω}(| [symbol] ₓₓ|²+2| [symbol] _{xy}|²+| [symbol] _{yy}|²)dΩ
that can be further simplified in the case of the cubic B-spline to the quadratic form [Eₛₘₒₒₜₕ( [symbol] (Θ))=Θ^{T}CΘ] with C a symmetric matrix.

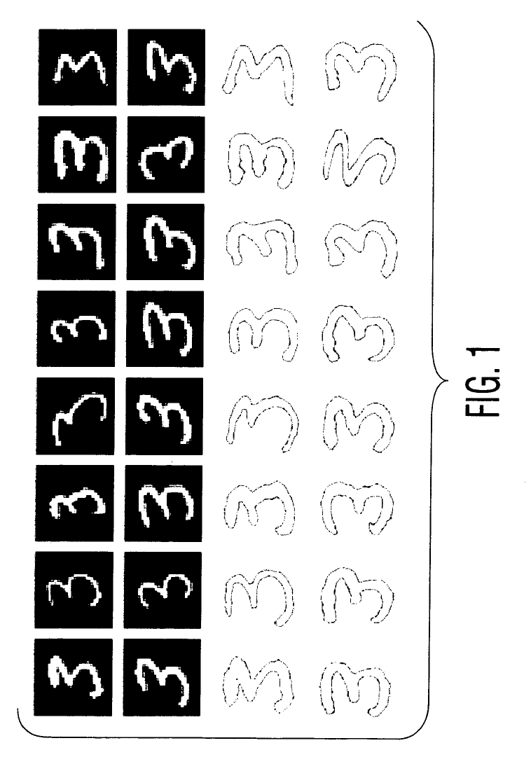

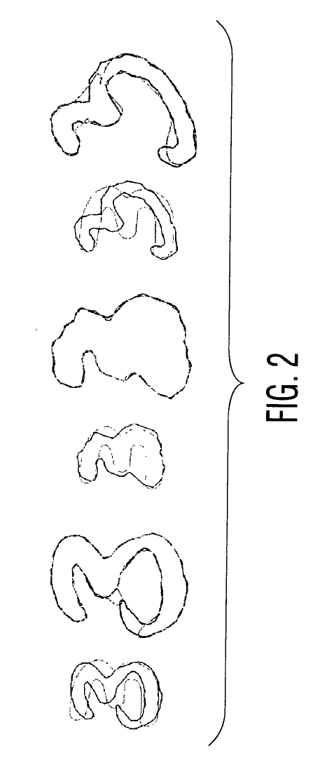

The objective function [E_{α}_{_{∞}}( [symbol] (Θ))+wEₛₘₒₒₜₕ( [symbol] (Θ))] can be optimized and/or improved using a standard gradient descent method leading to exceptional results. The method was tested for 2000 digits of the number “3” from the MNIST database and we qualitatively judged the registration results to be good in 98.2% of the cases. FIG. 1 shows some registration examples. The top two rows show the original image examples. Each example was globally aligned to the model using an affine transformation. Then, the FFD grid associated with the model was deformed to align to the example. The bottom three rows of FIG. 1 show the deformed model, the affine transformed example, and the deformation grid. What we observe is that the two contours coincide very well, which shows that the registration results are excellent. Some examples of cases where the method has failed are shown in FIG. 1. In the left example, the model did not deform enough. In the middle example, the model is perfectly aligned with the example, but the deformation grid contains a few irregularities. Finally, in the right example, a loop appears in the deformed model. These cases are very rare though, only 1.8% of the 2000 cases of “3”s.

However, one can claim that the local deformation field is not sufficient to characterize the registration between two shapes. Often data is corrupted by noise while at the same time outliers exist in the training set. Therefore recovering measurements of the quality of the registration is an eminent condition for accurate shape modeling.

Several attempts to build statistical models on noisy set of data in order to infer the properties of a certain model have been proposed. Various techniques have been reported to extract feature points in images along with uncertainties due to the inherent noise. An iterative estimation method has been proposed to handle uncertainty estimates of rigid motion on sets of matched points. An iterative technique to determine uncertainties within the ICP registration algorithm has been proposed. Uncertainties within the estimation of dense optical flow can be seen as a form of registration between images.

In the present case curves are considered using implicit representation, therefore uncertainty does not lie in the relative position of points but of an isosurface and therefore, the problem can be seen as equivalent to the “aperture problem” in optical flow estimation. Certain exemplary embodiments can recover uncertainties on the vector Θ while being able to use only the zero iso-surface of φ_{S}, defining the shape itself. To this end, we use a discrete formulation of the energy E₀=E_{α}_{_{∞}}, by summing along points regularly spaced on the source contour:

$${E}_{0} ( Θ ) = {\sum }_{i = 1}^{K} ρ ( {ϕ }_{𝒯} ( ℒ ( Θ , {x}_{i} ) ) = {\sum }_{i = 1}^{K} ρ ( {ϕ }_{𝒯} ( {x}_{t}^{′} ) )$$

Let us consider qᵢ to be the closest point on the target contour from x′ᵢ. Since φ_{T} is assumed to be a Euclidean distance transform, it satisfies the condition ||∇φ_{T}(x′ᵢ)||=1. Therefore one can express the values of φ_{T}(x′ᵢ):
φ_{T}(x′ᵢ)=∥x′ᵢ−qᵢ∥=(x′ᵢ−q_{i)∇φ}_{T}(x′ᵢ)

Then, a first order approximation of φ_{T}(x) in the neighborhood of x′ᵢ, might be in the form:

$$\begin{matrix}{ϕ }_{𝒯} ( {x}_{i}^{′} + δ {x}_{i}^{′} ) = {ϕ }_{𝒯} ( {x}_{i}^{′} ) + δ {x}_{i}^{′} ∇ {ϕ}_{𝒯} ( {x}_{i}^{′} ) \\ = ( {x}_{i}^{′} + δ {x}_{i}^{′} - {q}_{i} ) ∇ {ϕ }_{𝒯} ( {x}_{i}^{′} )\end{matrix}$$

that reflects the condition that a point to curve distance is adopted rather than a point to point. Under the assumption that E_{O}( [symbol] (Θ))=∘(1) we can neglect the second order term in the development of φ_{T} and therefore write the following second order approximation of E₀ in quadratic form:
E( [symbol] (Θ))=Σ[( [symbol] (Θ, xᵢ)−qᵢ)∇φ_{T}(x′ᵢ)]²

A free form deformation is a linear transformation with respect to the parameters Θ=δPᵢⱼ. Therefore one can rewrite this transformation over the image domain in a rather compact form:

$$\begin{matrix}ℒ ( Θ , x ) = x + {\sum }_{k = - 1}^{2} {\sum }_{l = - 1}^{2} {B}_{k} ( u ) {B}_{l} ( υ ) δ {P}_{i + k , j + l} \\ = x + χ ( x ) Θ .\end{matrix}$$

where χ(x) is a matrix of dimensionality 2×N with N being the size of Θ. One now can substitute this term in the objective function:

$$E ( Θ ) = {( \hat{χ} Θ - y )}^{T} ( χΘ - y )$$

$$with$$

$$\hat{χ} = ( \begin{matrix}{η}_{1}^{T} χ ( {x}_{1} ) \\ ⋮ \\ {η}_{K}^{T} χ ( {x}_{K} )\end{matrix} ) and y = ( \begin{matrix}{η}_{1}^{T} ( {q}_{1} - {x}_{1} ) \\ ⋮ \\ {η}_{K}^{T} ( {q}_{K} - {x}_{K} )\end{matrix} )$$

and [ηᵢ=∇φ_{T}(x′ᵢ)]. We assume that y is the only random variable. Such assumption is equivalent with saying that errors in the point positions are only quantified along the normal direction. This accounts for the fact that the point set is treated as samples extracted from a continuous manifold. One can take the derivative of the objective function in order to recover a linear relation between Θ and y:
\hat{χ}^{T}\hat{χ}Θ=\hat{χ}^{T}y

Last, assume that the components of y are independent and identically distributed. In that case, the covariance matrix of y has the form σ²I of magnitude σ² with I being the identity. In the most general case one can claim that the matrix \hat{χ}^{T}\hat{χ} is not invertible due to the fact that the registration problem is underconstrained. Additional constraints are to be introduced towards the estimation of the covariance matrix of Θ through the use of an arbitrarily small positive parameter γ:
E(Θ)=(\hat{χ}Θ−y)^{T}(\hat{χ}Θ−y)+γΘ^{T}Θ

Then the covariance matrix of the parameter estimate is:
ΣΘ=σ²(\hat{χ}^{T}\hat{+102}+γI)⁻¹

Some examples of such estimates are shown in FIG. 1 where 2×2 projections of the N×N uncertainty matrices are drawn on the grid points.

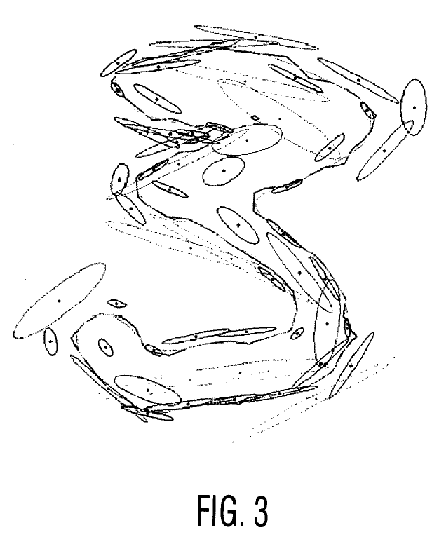

FIG. 3 is a projection of the covariance matrix Σ_{Θ} on grid points.

Modeling the registered examples according to some density function is the next step. To this end, two critical issues are to be addressed: the form of the PDF as well as the procedure to determine the corresponding parameters. In the most general case deformations of shapes that refer to entities of particular interest cannot be modeled with simple parametric models like Gaussians. Therefore within our approach we propose a non-parametric form of the probability density function (PDF).

Let {xᵢ}ᵢ₌₁^{M} denote a random sample with common density function ƒ. The fixed bandwidth kernel density estimator consists of:

$$\begin{matrix}\hat{f} ( x ) = \frac{1}{M} {\sum }_{i = 1}^{M} {K}_{H} ( x - {x}_{i} ) \\ = \frac{1}{M} {\sum }_{i = 1}^{M} \frac{1}{{‖ H ‖}^{1 / 2}} K ( {H}^{- 1 / 2} ( x - {x}_{i} ) )\end{matrix}$$

where H is a symmetric definite positive—often called a bandwidth matrix—that controls the width of the kernel around each sample point xᵢ. The fixed bandwidth approach often produces undersmoothing in areas with sparse observations and oversmoothing in the opposite case. Usefulness of varying bandwidths is widely acknowledged to estimate long-tailed or multi-modal density functions with kernel methods.

Kernel density estimation methods that rely on such varying bandwidths are generally referred to as “adaptive kernel” density estimation methods. Two useful state of-the-art variable bandwidth kernels are the sample point estimator and the balloon estimator.

The “sample point estimator” refers to a covariance matrix depending on the repartition of the points constituting the sample:

$$\hat{f} 𝓈 ( x ) = \frac{1}{M} {\sum }_{i = 1}^{M} \frac{1}{{‖ H ( {x}_{i} ) ‖}^{1 / 2}} K ( {H ( {x}_{i} )}^{- 1 / 2} ( x - {x}_{i} ) )$$

where a common selection of H is H(xᵢ)=h(xᵢ) with h(xᵢ) being the distance of point xᵢ from the k^{th} nearest point. One can consider various alternatives to determine the bandwidth function. Such estimator may be directly used with the uncertainties calculated, supra, and H(xᵢ)=μΣ_{Θ}.

The “balloon estimator” adapts to the point of estimation depending on the shape of the sampled data according to:

$${\hat{f}}_{B} ( x ) = \frac{1}{M} {\sum }_{i = 1}^{M} \frac{1}{{‖ H ( x ) ‖}^{1 / 2}} K ( {H ( x )}^{- 1 / 2} ( x - {x}_{i} ) )$$

where H(x) may be chosen with the same model as for the “sample point estimator.” Such function may be seen as the average of a density associated with the estimation point x on all the sample points xᵢ. One should point out that such a process could lead to estimates on \hat{ƒ}(x) that do not refer to density function because it might be discontinuous and its integral is infinity.

Let us consider {xᵢ}ᵢ₌₁^{M} a multi-variate set of measurements where each sample xᵢ exhibits uncertainties in the form of a covariance matrix Σᵢ; Our objective can be stated as follows: estimate the probability of a new measurement x that is associated with covariance matrix Σ.

Let X be the random variable associated with the training set and assume a density function f. f may be estimated with \hat{ƒ} using the “sample point estimator.” Therefore \hat{ƒ} may be expressed in the form \hat{ƒ}=Σ\hat{ƒ}ᵢ where \hat{ƒ}ᵢ are densities associated with a single kernel {xᵢ, H(xᵢ)}. Let Y be a random variable for the new sample with estimated density ĝ.

Then one can claim that in order to estimate the probability of the new sample, one should first determine for all possible u ∈ R^{N} their distance \hat{ƒ}(u) from the existing kernels of the training set X and weight them according to their fit with the estimated density function of Y:

$$\begin{matrix}py = \int \hat{f} ( u ) \hat{g} ( u ) ⅆ u \\ = \int [ {\sum }_{i = 1}^{M} {f}_{i} ( t ) ] g ( t ) ⅆ t = {\sum }_{i = 1}^{M} [ \int {f}_{i} ( t ) g ( t ) ⅆ t ]\end{matrix}$$

In the case of Gaussian kernels for g (centered at x) and the ƒᵢ (centered at xᵢ)the following expression is recovered:

$${\hat{f}}_{G} ( x ) = \frac{1}{{M ( 2 π )}^{d / 2}} {\sum }_{i = 1}^{M} \frac{1}{‖ Σ + {Σ}_{i} ‖} {exp ( - \frac{1}{2} ( x - {x}_{i} ) )}^{⊤} {( Σ + {Σ}_{i} )}^{- 1} ( x - {x}_{i} ) )$$

Such an expression has a simple mathematical interpretation: Consider two points {x₁, x₂} with associated uncertainty {Σ₁, Σ₂}. Assuming that these are the parameters (mean and variance) of two independent random variables with normal distribution
{X₁˜N(x₁, Σ₁), X₂˜N(x₂, Σ₂)}

Then the random variable Z=X₁−X₂ follows a distribution N(x₁−x₂, Σ₁+Σ₂) and the density at Z=0 is given by

$$p ( {X}_{1} = {X}_{2} ) = \frac{1}{{( 2 π )}^{d / 2} {‖ {Σ}_{1} + {Σ}_{2} ‖}^{1 / 2}} {exp ( - \frac{1}{2} ( {x}_{1} - {x}_{2} ) )}^{T} {( {Σ}_{1} + {Σ}_{2} )}^{- 1} ( {x}_{1} - {x}_{2} ) )$$

The present concept could be relaxed to address the case of non-Gaussians kernels according to a hybrid estimator that is considered in the present paper:

$$\begin{matrix}{\hat{f}}_{H} ( x ) = \frac{1}{N} {\sum }_{i = 1}^{M} 𝒦 ( x , Σ , {x}_{i} , {Σ}_{i} ) \\ = \frac{1}{M} {\sum }_{i = 1}^{M} \frac{1}{{‖ H ( Σ , {Σ}_{i} ) ‖}^{1 / 2}} K ( {H ( Σ , {Σ}_{i} )}^{- 1 / 2} ( x - {x}_{i} )\end{matrix}$$

Such a density estimator takes into account the uncertainty estimates both on the sample points themselves as well as on the estimation of point x. The outcome of this estimator may be seen as the average of the probabilities that the estimation measurement is equal to the sample measurement, calculated over all sample measurements. Consequently, the density estimation decreases more slowly in directions of large uncertainties.

This measure can now be used to assess the probability for a new sample of being part of the modeled class in an approach that accounts for the non-parametric form of the observed density. The problem however is that this technique is very time consuming since the computation is linear in the number of samples in the training set. Therefore, there is an eminent need on decreasing the cardinality of the set of retained kernels.

The goal is to select a subset of kernels to maximize the likelihood of the training set. Consider a set Zₖ={X₁,X₂,Xₖ) of kernels extracted from the training set. These have associated mean and uncertainties {Xⱼ={xᵢΣᵢ}}ᵢ₌₁^{K}. The log likelihood of the entire training set according to this model is:

$${C}_{K} = {\sum }_{i = 1}^{M} log ( \frac{1}{K} {\sum }_{( {x}_{j} , {Σ}_{j} ) ∈ {Z}_{K}} 𝒦 ( {x}_{j} , {Σ}_{j} , {x}_{i} , {Σ}_{i} ) )$$

Where {Yⱼ={xⱼ, Σⱼ}}ⱼ₌₁^{M} denote the kernels of the training set. We use an efficient sub-optimal iterative algorithm to update the set Zₖ. A new kernel Y={x, Σ} is extracted from the training set as the one maximizing the quantity Cₖ₊₁ associated with [symbol] _{K+1}= [symbol] _{K}∪Y. One kernel may be chosen several times in order to preserve a decreasing order of Cₖ when adding new kernels. Consequently the selected kernels Xᵢ in Zₖ are also associated with a weight factor wᵢ. Once such a selection has been completed, the hybrid estimator is evaluated over Zₖ.

$${\hat{f}}_{H} ( x , Σ ) = {\sum }_{( {x}_{i} , {Σ}_{i} , {w}_{i} ) ∈ {Z}_{K}} {w}_{i} . 𝒦 ( x , Σ , {x}_{i} , {Σ}_{i} )$$

Certain exemplary embodiments can provide efficient models for family of shapes. Handwritten digits exhibit a very large variation among individual examples. Based on this observation, we have learned the shape of three different digits, namely, 3, 4, and 9. In a test, 2000 examples of each digit from MNIST digit database were used to build the model. The kernel selection algorithm was used to retain 50 kernels.

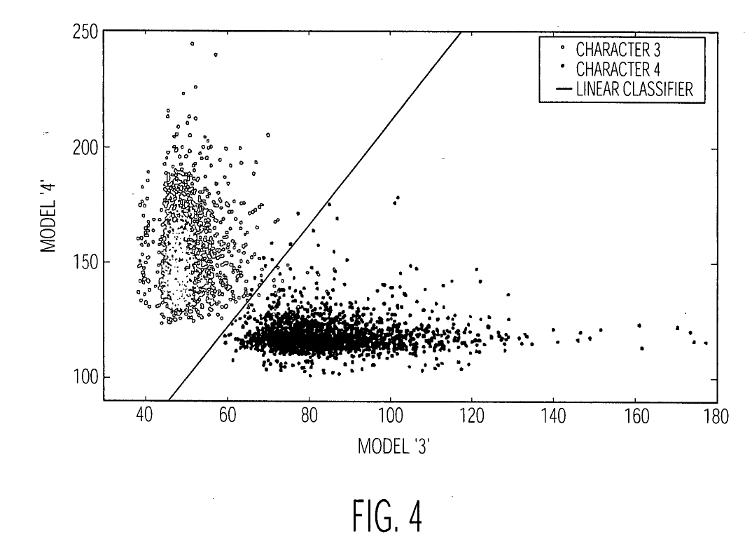

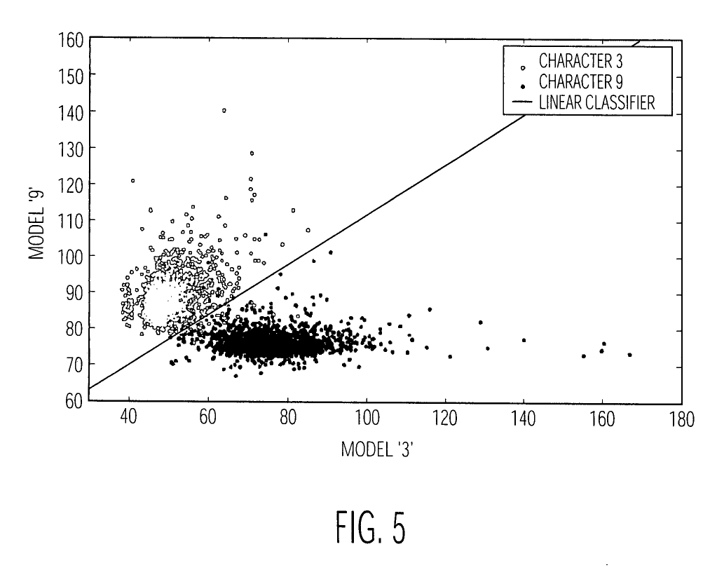

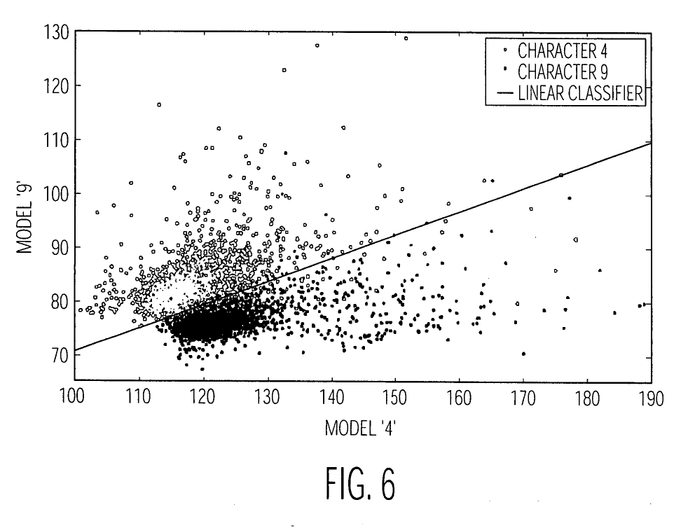

To verify that an exemplary method can encode the shape properties of the class of entities of interest, we ran a cross validation test, where each of the 3 models was registered to all 6000 digits. The hybrid estimator for the probability of the digit belonging to the class of the model was computed. FIG. 4, FIG. 5, and FIG. 6 show the results. FIG. 4 represents the matching of 3″s and 4″s. The X-axis is the likelihood that an example belongs to the class of “3” (−log(ƒ(x, Σ))) and the Y-axis is the likelihood that an example belongs to the class “4”. It can be seen that the two classes are very well separated. To demonstrate the separation, a simple support vector machine classifier was used to linearly separate the two classes in the space of likelihood measured. The linear boundary is also shown in FIG. 4. The correct classification rate was 99.17%. FIG. 5 illustrates the separation between classes 3 and 9; the correct classification rate was 98.73%. Finally, FIG. 6 illustrates the separation between classes 4 and 9; the correct classification rate was 98.73%. Table 1 shows the overall confusion matrix.

FIG. 4 is a distribution of the digits 3 and 4 in the space of likelihoods of belonging to the classes “3” and “4”.

FIG. 5 is a distribution of the digits 3 and 9 in the space of likelihoods of belonging to the classes “3” and “9”.

FIG. 6 is a distribution of the digits 4 and 9 in the space of likelihoods of belonging to the classes “4” and “9”.

TABLE 1

| | “3” | “4” | “9” |
|---|---|---|---|
| “3” | 0.9845 | 0.0065 | 0.0090 |
| “4” | 0.0045 | 0.9385 | 0.0570 |
| “9” | 0.0145 | 0.0425 | 0.943 |

Table 1 is a confusion matrix between the three classes of digits 3, 4, and 9. The results are consistent with what was expected. The lowest classification rate was obtained when comparing the 4″s and the 9″s. These digits are indeed very similar when handwritten by Americans, as can be seen from FIG. 5. We can also see that 3 and 9 look more alike than 3 and 4. It is important to note that the proposed method is not intended for such an application. However, given this validation we claim that such a model can capture samples of increasing complexity. Also, the use of deformations along with uncertainties provides efficient density estimators.

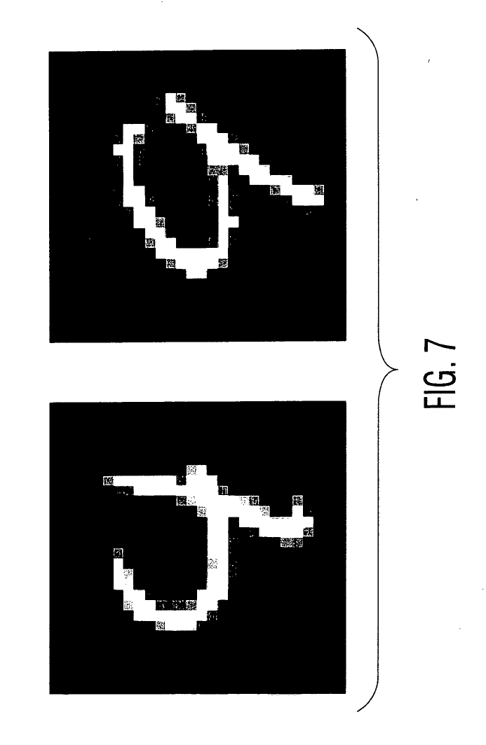

FIG. 7 is a diagram illustrating that digits 4 and 9 can be very similar.

We have introduced an original framework to estimate uncertainty in the process of registration of shapes. Certain exemplary embodiments can build an efficient probabilistic descriptor of a certain class of shapes.

First, in the registration process, uncertainties could be propagated through scale when updating the transformation. The uncertainties calculated on a certain FFD-grid could be extended to any finer grid and therefore qualify the density probability of any image transformation without the limitation of the choice of parameters.

Another path will be the exploration of the kernel used to make a Parzen-Window like density estimation into more advanced kernel-based learning methods such as kernel-PCA. The issue of defining the right Mercer kernel has however to be addressed.

This evaluation of densities using uncertainty has to be exported to the more general problem of image registration with prior knowledge. Consider an original image used as a model with the region of interest manually delineated. Then, registration can be performed with a shape term that directly handles the parameters of the transformation [symbol] . Eventually, a calculation of uncertainties qualifying the present image registration may enhance the confidence for this term when using the hybrid estimator.

Segmentation tasks are most often designed specifically for a particular application that requires retrieving a certain class of shapes in a noisy or cluttered image. However, these classes of shapes also present variations that have to be accounted for in the segmentation step. Building a whole segmentation framework able to perform such a task is divided into steps. The first step comprises building a statistical model for a given class of shapes.

Such modeling phase usually consists of extracting all the information from a set of data representing the class (the training set) and building a probability density function out of the information. This should quantify how likely it is for a new shape to belong to the learned class. Learning is usually made of two steps: (i) representing the shapes as a finite vector of scalar value (ii) Building a statistical estimator out of these data.

The first step deals with the issue of shape registration. This is related to the choice of the basis to represent shapes. If no modification is made to the data and vectors built directly from the raw training set, the variability of the set is so high that no meaningful probability function might be inferred. Certain exemplary embodiments build correspondences between shapes and register all the shapes in the training set to a common pose with respect to an affine transformation.

Now consider that all the “3”s of the training set are registered with respect to an affine transform to a common model of “3”. Then the variability of this new set of shapes will only contain local transformations. A learning framework can account for these local variations.

The learning process is performed using points. In the case of shapes every single shape is associated to a point in an N-dimensional space, and the learning process consists in finding the distribution of this set of points. Certain exemplary embodiments consider that a shape in the training set actually contains more information than could be stored in a single point.

Certain exemplary embodiments can represent a shape with the parameters of the transformation that transforms the model into it. This class of transformation is called free form deformation. The displacement of the points of the square lattice (14×16) produces a regular deformation of the shape that lies under. Therefore the vector of parameters used to model a shape is simply made of the displacement of all the control points (2*14*16=448).

However the transformation that warps the model to a shape of the training set is not unique. Actually we may even say that it does not exist since the number of degree of freedom for the transformation is not sufficient to reach a perfect match. The framework allows finding the “best” transformation in terms of the minimum of an energy quantifying the quality of the match.

Finally the recovered transformation can depend on the choice of this energy and little details on the shape to register, a different choice would lead to a different solution that is still visually acceptable.

Once the shape is registered and we have reached the minimum of the energy, the uncertainty in the registration can be evaluated. To do so, we consider the displacements of the control points that does not affect the visual aspect of the shape and therefore cause a minimum increase in the energy. This is the meaning of the second order approximation of the energy computed in the neighborhood of the minimum:E(Θ)=(\hat{χ}Θ−y)^{T}(\hat{χ}Θ−y). In the present case the variability will be explained with the fact that we are registering curves: therefore the transformation is highly constrained in the normal direction but presents no constraints in the tangential direction. This is the reason why, when representing the results, we find elongated ellipses in the direction of the contour on the control points.

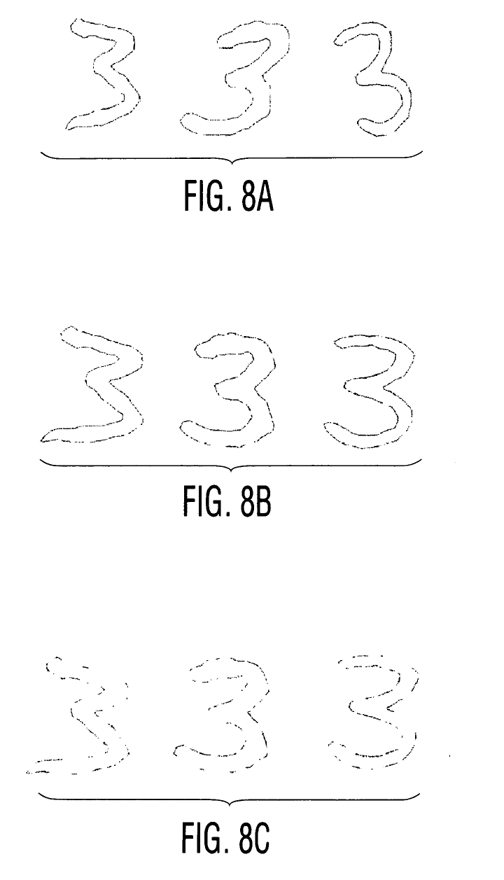

FIG. 8A is an exemplary drawing illustrating the registration process in an initial state. FIG. 8B is an exemplary drawing illustrating the registration process after registration of the training samples to the model with respect to an affine transform. FIG. 8C is an exemplary drawing illustrating the registration process after free form deformation of the model to warp to the training samples.

Another way to think about this is the following. Conventional registration finds the best transformation; ours actually finds an infinite number of transformations with an associated weight. This also relates the minimization of an energy, “E”; with the retrieval of the principal mode of a probability density function α exp(E/β). The second order approximation of the energy is associated to a Gaussian distribution of the registration parameters with covariance matrix Σ_{Θ}=σ²(\grave{χ}^{T}\acute{χ}+γI)⁻¹, which we call uncertainty matrix.

Finally, out of a single shape of the training set we consider that many other shapes, quite similar in terms of energy are also likely to belong to the same class. This is a really important point because the probabilistic estimators usually do not account for the choice of the energy used to register the shape. When representing all shapes with a Gaussian distribution it actually does.

In certain exemplary embodiments, the registration process uses a distance transform, affine and FFD-transformation. Retrieval of feature points in images (strong edge) are also sensitive to noise, therefore certain exemplary embodiments utilize methods to estimate uncertainty in the position of these points. Certain exemplary embodiments comprise a framework to register corresponding landmarks on images where each landmark also presents an uncertainty ellipse (i.e., Gaussian distribution) in position. Registering two sets of corresponding landmarks points, certain exemplary embodiments estimate the uncertainty in the transformation (which is an affine transformation only). The framework to the case points to surface registration. Certain exemplary embodiments utilize an affine transformation. Uncertainty in the registration can be used to automatically determine the number of parameters in the transformation and the size of the area to be registered in the image.

Certain exemplary embodiments utilize surface registration of a known model to noisy data in the case of Free Form Deformation. Density Estimation and Shape Testing Modeling the statistics of the shape may be performed using various methods. The first point consists of selecting the nature of the distribution and retrieving its parameters. Active shape models (ASM) assume that the shapes are distributed according to a Gaussian distribution and estimate the parameters using principal component analysis (PCA). This can be a Gaussian assumption using PCA. This can be extended to more complex distributions like Gaussian mixtures using for instance the expectation maximization (EM) algorithm.

In certain exemplary embodiments, distribution of shapes modeled as N dimensional points cannot be considered as Gaussian or mixtures of Gaussians. Non parametric approaches use kernels and Parzen Window density estimation. Such technique is however computationally expensive, space reduction is desirable as is the use of kernel PCA for shape modeling. However, such framework cannot account for the variability in the information carried by a single shape in terms of the uncertainty covariance matrix. We therefore use non parametric density estimation using kernels with variable bandwidth (set according to the uncertainty previously estimated). Certain exemplary embodiments can consider a 5 dimensional space of speed (estimated with optical flow methods) and color. Learning was performed, in the 5 dimensional space, independently for every point of a video display during a long period. In the present work, we follow the same line considering the N(=448)-dimensional space of parameters for the Free Form Deformation.

Once all the shapes in the training set have been registered and the associated uncertainty matrices have been computed, these pieces of information are accumulated with a kernel based estimator. Assuming that each shape in the training is modeled using a Gaussian distribution, this kernel-based estimator consists of summing up all the probability density functions (the sample point estimator \hat{ƒ}s).

Certain exemplary embodiments can assess the probability of a new shape. Consider a new shape that has to be tested, first it is registered to the model with respect to an affine transform, then, the model is transformed using free form deformation to match the shape candidate. This matching step (energy minimization) leads to a set of parameters x that could be used to compute the likelihood of this shape (\hat{ƒ}s(x)) However, uncertainties for the registration of the shape candidate are also computed. So the candidate shape is not considered as unique but with a Gaussian distribution also presenting variabilities.

This is the reason why we have used the hybrid (\hat{ƒ}s) estimator in our framework: the important question is whether the probability density function associated to the training set (\hat{ƒ}s) and to the shape candidate overlap. Denote X the random variable associated with the training set and Y the one associated with the candidate shape, this hybrid estimator calculates the probability of Y−X=0.

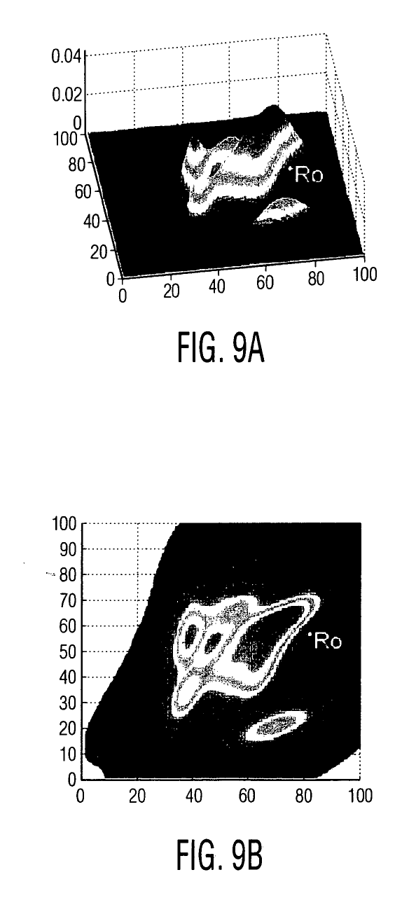

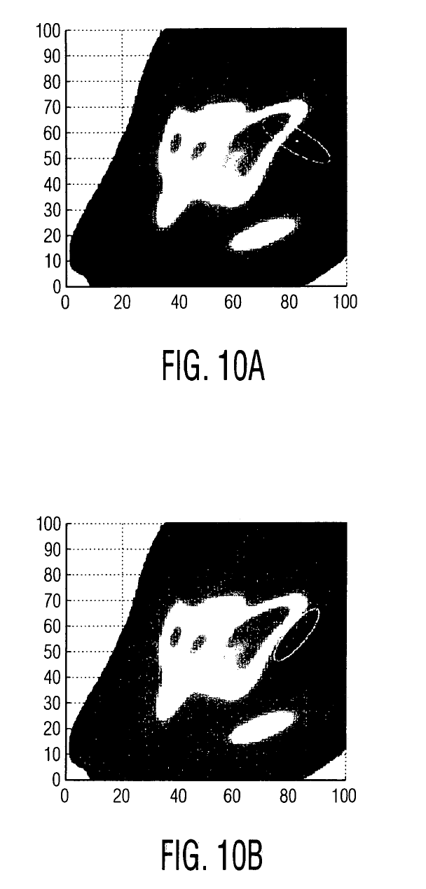

FIG. 9A, FIG. 9B, FIG. 10A, and FIG. 10B illustrate the density probability estimation as a surface in a 3D space (P(x, y), FIG. 9A) and Ro=(x₀, y₀) the point candidate corresponding to the registration (FIG. 9B) of the model to a new shape candidate. The white ellipses in FIG. 10A and FIG. 10B represent the uncertainty in the registration of this candidate. The likelihood can be seen as a weighted integration of P on the ellipse. Therefore cases where the ellipse partly overlaps peaks of the density estimation (see FIG. 10A) are more favorable than cases where it does not (see FIG. 10B).

Certain exemplary embodiments comprise a novel variational technique for the knowledge based segmentation of two dimensional entities. One of the elements of our approach is the use of higher order implicit polynomials to represent shapes. Certain exemplary embodiments comprise the estimation of uncertainties on the registered shapes, which can be used with a variable bandwidth kernel-based nonparametric density estimation process to model prior knowledge about the entity of interest. Such a non-linear model with uncertainty measures is integrated with an adaptive visual-driven data term that aims to separate the entity of interest from the background. Promising results obtained for the segmentation of the corpus callosum in MR mid-sagittal brain slices demonstrate the potential of such a framework.

Certain exemplary embodiments can utilize active shape models (ASM) and active appearance models (AAM) for the segmentation of anatomical structures in medical images. Principal component analysis (PCA) can applied to distance transforms for an implicit representation of shapes. Shape-based segmentation is usually equivalent to recovering a geometric structure which is both highly probable in the model space and well aligned with strong features in the image. The advantage of the shape based methods over deformable templates is that they allow the deformation process to be constrained to remain within the space of allowable shapes. These methods can be a compromise between complexity and shape generalization. However, since modeling is performed after registration, errors in the registration can be propagated into the model space. Furthermore, the assumption of Gaussian shape models might be a little restrictive.

In certain exemplary embodiments, shapes can be represented implicitly using the distance transform. To generate a model of the structure of interest, we register shape examples using a spline based free form deformation. Certain exemplary embodiments comprise the derivation of a measure representing the uncertainty of the registration at the zero iso-surface. After dimensionality reduction, these measures are combined with a variable bandwidth kernel-based approach to derive a density function that models the family of shapes under consideration. Given a new image, the segmentation process is expressed in a variational level set framework where the energy function makes use of the uncertainties of the registration between the deformed shape which aligns to the image features and the model.

We apply our novel modeling and segmentation technique to the case of the corpus callosum. The corpus callosum is a thick bundle of nerve fibers that connect the left and right hemispheres in the brain. It is believed to be responsible for balancing the load of learning tasks across each hemisphere, making each specialized in certain tasks. While not learning, it is responsible for routing most of the communication between the two hemispheres. This is the reason why a surgical procedure has been developed to cut the corpus callosum in patients with severe epilepsy for which drug treatment is ineffective. In addition, several studies indicate that the size and shape of the corpus callosum is related to various types of brain dysfunction such as dyslexia or schizophrenia. Therefore, neurologists are interested in looking at the corpus callosum and analyzing its shape. Magnetic resonance imaging (MRI) is a safe and non-invasive tool to image the corpus callosum. Since manual delineation can be very time consuming, we demonstrate how our algorithm can be used to segment the corpus callosum on mid-sagittal MR slices.

Let us consider a training set {C₁,C₂, . . . , C_{N}} of shapes representing the structure of interest. The model building task consists of recovering a probabilistic representation of this set. In order to remove all the pose variation from the training set, all shapes have to be registered to a common pose with respect to an affine transformation. Then a reference model C_{M} is locally registered to every sample of the training set Cᵢ using implicit polynomials. We will first describe the registration process and the calculation of uncertainties on the registered model. The uncertainty measures represent the allowable range of variations in the deformations of the model that still match Cᵢ. Then we describe the way these uncertainties are used in the estimation of probability density function of the deformations.

Certain exemplary embodiments comprise an initial step used to recover explicit correspondence between the discretized contour of the model shape and the training examples. In the present framework, the model shape is non-rigidly registered to every sample from the training, and the statistical shape model is actually built on the parameters of the recovered transformation. Shapes Cᵢ are represented in an implicit fashion using the Euclidean distance transform. In the 2D case, we consider the function defined on the image domain Ω:

$${ϕ}_{{C}_{i}} ( x ) = \{ \begin{matrix}0 , & x ∈ {C}_{i} \\ + 𝒟 ( x , {C}_{i} ) , & x ∈ {ℛ}_{{C}_{i}} \\ - 𝒟 ( x , {C}_{i} ) , & x ∉ {ℛ}_{{C}_{i}}\end{matrix}$$

where R_{C}_{₁} is the region enclosed by Cᵢ. Such a space is invariant to translation, rotation and can also be modified to account for scale variations. This representation can be used along with simple criteria like sum of squared differences to address similarity registration or mutual information for affine transformations.

The retained framework for density estimation does not put any constraint on the reference model used for registration. In practice we choose a shape characteristic of the entity to segment. Without loss of generality, we can choose for C_{M} a smoothed version of C₁. All contours of the training set are now registered to C_{M} with respect to an affine transform and from now on, we will denote {C₁,C₂, . . . ,C_{N}) as the globally registered training set.

Local registration can be utilized in model building. To this end one would like to recover an invertible transformation (diffeomorphism) [symbol] Θ parameterized by a vector Θᵢ that creates a one to one mapping between each contour of the training set _{ci} and the model C_{M}: [symbol]
_{Θ}:R²→R² and [symbol] _{Θ}(C_{M})≈Cᵢ

When [symbol] _{Θ} is chosen as a 2D polynomial with coefficients Θ in an appropriate basis, the expression φ∘ [symbol] _{Θ} inherits the invariance properties of implicit polynomials, i.e. linear transformations applied to Θ are related to linear transformations applied to the data space. In certain exemplary embodiments, a simple polynomial warping technique can address the demand of local registration: the free form deformations method (FFD). FFD can deform an entity by manipulating a regular control lattice overlaid on its embedding space. We use a cubic B-spline FFD to model the local transformation [symbol] . Consider the M×N square lattice of points, [{P_{m,n}⁰};(m,n)∈1,M]×[1;N]]. In this case the vector of parameters Θ defining the transformation [symbol] is the displacement coordinates of the control lattice. Θ has size 2MN
Θ={δP_{m,n}^{x}, δP_{m,n}^{y}};(m, n) ∈ [1;M]×[1;N].

The motion of a pixel x given the deformation of the control lattice, is defined in terms of a tensor product of Cubic B-splines. As FFD is linear in the parameter Θ=δP, it can be expressed in a compact form by introducing X(x)a[2×2MN] matrix: [symbol]
(Θ;x)=ΣΣBᵢ(u)Bⱼ(v)(P_{i,j}+δP_{i,j})=x+X(x)Θ
where (u, v) are the coordinates of x, and (Bᵢ, Bⱼ) the cubic B-spline basis functions.

Local registration now is equivalent to finding a lattice configuration such that the overlaid structures coincide. Since structures correspond to distance transforms of globally aligned shapes, the sum of squared differences (SSD) can be considered as the data-driven term to recover the deformation field [symbol] (Θ;x) between the element Cᵢ of the training set and the model C_{M} (corresponding respectively to the distance transform φᵢ and φM)
E_{data}(Θ)=∫∫_{Ω}χ_{α}(φi(x))[φᵢ( [symbol] (Θ;x))−φ_{M}(x)²dx (1)
with χ_{α}(φᵢ(x)) being an indicator function that defines a band of width α around the contour. In order to further preserve the regularity of the recovered registration, one can consider an additional smoothness term on the deformation field δ [symbol] . We consider a computationally efficient smoothness term:
Eₛₘₒₒₜₕ(Θ)=∫∫_{Ω}(| [symbol] ₓₓ(Θ;x)|²+2| [symbol] _{xy}(Θ;x)|²+| [symbol] _{yy}(Θ;x)|²)dx.

The data-driven term and the smoothness constraint component can now be integrated to recover the local deformation component through the calculus of variations. We denote as Θᵢ the reached minimum. However, one can claim that the local deformation field is not sufficient to characterize the registration between two shapes. Data is often corrupted by noise so that the registration retrieved using a deformable model may be imprecise. Therefore, recovering uncertainty measurements that do allow the characterization of an allowable range of variation for the registration process is a condition of accurate shape modeling.

We aim to recover uncertainties on the vector Θ in the form of a [2MN×2MN] covariance matrix. We are considering the quality of the local registration on shapes that is the zero level set of the distance transform. Therefore, E_{data} is formulated in the limit case where α, the size of the limited band around the model shape, tends to 0. The data term of the energy function can now be expressed as:
E_{data}(Θ)= [symbol] _{C}_{_{M}}φᵢ²( [symbol] (Θ; x))dx=_{C}_{_{M}}φᵢ²(x′)dx
where we denote x′= [symbol] (Θᵢ; x). Let us consider q to be the closest point from x′ located on Cᵢ. As φᵢ is assumed to be a Euclidean distance transform, it also satisfies the condition ||∇φᵢ(x′)||=1. Therefore one can express the values of φᵢ at the first order in the neighborhood of x′ in the following manner:

$$\begin{matrix}{ϕ}_{i} ( {x}^{′} + δ {x}^{′} ) = {ϕ}_{i} ( {x}^{′} ) + δ {x}^{′} \cdot ∇ {ϕ}_{i} ( {x}^{′} ) + o ( δ {x}^{′} ) \\ = ( {x}^{′} + δ {x}^{′} - q ) \cdot ∇ {ϕ}_{i} ( {x}^{′} ) + o ( δ {x}^{′} )\end{matrix}$$

This local expression of φᵢ with a dot product reflects the condition that a point to curve distance was adopted. Under the assumption that E_{data} is small when reaching the optimum, we can write the classical second order approximation of quadratic energy in the form:
E_{data}(Θ)= [symbol] _{C}_{_{M}}[(x′−q)·∇φᵢ(x′)]²= [symbol] _{C}_{_{M}}[x+χ(x)Θ−q)·∇φᵢ(x′)]²

Localizing the global minimum of an objective function E is equivalent to finding the major mode of a random variable with density exp(−E/β). The coefficient β corresponds to the allowable variation in the energy value around the minimum. In the present case of a quadratic energy (and therefore Gaussian random variable), the covariance and the Hessian of the energy are directly related by Σ_{Θ}⁻¹=H_{Θ}/β. This leads to the following expression for the covariance:

$${Σ}_{{Θ}_{i}}^{- 1} = \frac{1}{β} {∮}_{{𝒞}_{ℳ}} {𝒳 ( x )}^{T} . ∇ {ϕ}_{i} ( {x}^{′} ) . ∇ {{ϕ}_{i} ( {x}^{′} )}^{T} . 𝒳 ( x ) ⅆ x$$

In the most general case one can claim that the matrix H_{Θ} is not invertible because the registration problem is under-constrained. Then, additional constraints have to be introduced towards the estimation of the covariance matrix of Θᵢ through the use of an arbitrarily small positive parameter:
E(Θ)= [symbol] _{C}_{_{M}}[(x+χ(x)Θ−q)·∇φᵢ(x′)]²dx+γΘ^{T}Θ

This leads to the covariance matrix for the parameter estimate:
ΣΘ=β( [symbol] _{C}_{_{M}}χ(x)^{T}∇φᵢ(x′)∇φᵢ(x′)^{T}χ(x)dx+γI)⁻¹ (2)

Now that shapes of the training set have been aligned, standard statistical techniques like PCA or ICA could be applied to recover linear Gaussian models. But in the most general case shapes that refer to entities of particular interest vary non-linearly and therefore the assumption of simple parametric models likes Gaussian is rather unrealistic. Therefore within our approach we propose a non-parametric form of the probability density function.

Let {Θ₁ . . . Θ_{N}} be the N vectors of parameters associated with the registration of the N sample of the training set. Considering that this set of vectors is a random sample drawn from the density function ƒ describing the shapes, the fixed bandwidth kernel density estimator consists of:

$$\hat{f} ( Θ ) = \frac{1}{N} {\sum }_{i = 1}^{N} \frac{1}{{‖ H ‖}^{1 / 2}} K ( {H}^{- 1 / 2} ( Θ - {Θ}_{i} ) )$$

where H is a symmetric definite positive (bandwidth matrix) and K denote the centered Gaussian kernel with identity covariance. Fixed bandwidth approaches often produce under-smoothing in areas with sparse observations and over-smoothing in the opposite case.

Kernels of variable bandwidth can be used to encode such a condition and provide a structured way for utilizing the variable uncertainties associated with the sample points. Kernel density estimation methods that do rely on varying bandwidths can be referred to as adaptive kernels. Density estimation is performed with kernels whose bandwidth adapts to the sparseness of the data.

In the present case, the vectors {Θᵢ} if come along with associated uncertainties {Σᵢ}. Furthermore, the point Θ where the density function is evaluated corresponds to a deformed model, and therefore is also associated to a measure of uncertainty Σ. In order to account for the uncertainty estimates both on the sample points themselves as well as on the estimation point, we adopt a hybrid estimator.

$$\begin{matrix}{\hat{f}}_{H} ( Θ , Σ ) = \frac{1}{N} {\sum }_{i = 1}^{N} K ( Θ , Σ , {Θ}_{i} , {Σ}_{i} ) \\ = \frac{1}{N} {\sum }_{i = 1}^{N} \frac{1}{{‖ H ( {Σ}_{Θ} , {Σ}_{{Θ}_{i}} ) ‖}^{1 / 2}} K ( {H ( {Σ}_{Θ} , {Σ}_{{Θ}_{i}} )}^{- 1 / 2} ( Θ - {Θ}_{i} )\end{matrix}$$

where we choose for the bandwidth function: H(Σ_{Θ}Σ_{Θ})=Σ_{Θ}Σ_{Θ}. Using this estimator, the density decreases more slowly in directions of large uncertainties when compared to the other directions.

This metric can now be used to assess the probability of a new sample being part of the training set and account for the non-parametric form of the observed density. However, the computation is time consuming because it leads to the calculation of large matrix inverses. Since the cost is linear in the number of samples in the training set, certain exemplary embodiments can decrease its cardinality by selecting representative kernels.

The maximum likelihood criterion expresses the quality of approximation from the model to the data. We use a recursive sub-optimal algorithm to select kernels and therefore build a compact model that maximizes the likelihood of the whole training set. Consider a set Z_{K}={X₁,X₂, . . . ,X_{K}} of K kernels extracted from the training set with mean and uncertainties estimates {Xᵢ=(ΘᵢΣᵢ)}ₜ₌₁^{K}. The log likelihood of the entire training set according to this model is:

$${C}_{K} = {\sum }_{i = 1}^{N} log ( \frac{1}{K} {\sum }_{( {Θ}_{j} , {σ}_{j} ) ∈ {ℨ}_{K}} K ( {Θ}_{j} , {Σ}_{i} , {Θ}_{i} , {Σ}_{i} ) )$$

A new kernel X_{K+1} is extracted from the training set as the one maximizing the quantity C_{K+1} associated with [symbol] _{K+1}= [symbol] _{K}∪X_{K+1}. The same kernel may be chosen several times in order to preserve an increasing sequence C_{K}. Consequently the selected kernels Xᵢ in Z_{K} are also associated with a weight factor wᵢ. Once such a selection has been completed, the hybrid estimator is evaluated over Z_{K}:

$${\hat{f}}_{H} ( Θ , Σ ) = \frac{1}{N} {\sum }_{( {Θ}_{i} , {σ}_{i} , {ω}_{i} ) ∈ {Z}_{K}} {ω}_{i} K ( Θ , Σ , {Θ}_{i} , {Σ}_{i} ) \qquad ( 3 )$$

Let us consider an image I where the corpus callosum structure is present and is to be recovered. Recall that we now have a model of the corpus callosum: a shape that can be transformed using an affine transformation and a FFD, and a measure of how well the deformed shape belongs to the family of trained shapes.

Let φ_{M} be the distance transform of the reference model. Segmentation consists of globally and locally deforming φ_{M} towards delineating the corpus callosum in I. Let A be an affine transformation of the model and [symbol] (Θ) its local deformation using FFD as previously introduced.

For now, we assume that the visual properties of the corpus callosum π_{cor}( ) as well as the ones of the local surrounding area π_{bck}( ) are known. Then segmentation of the corpus callosum is equivalent to an attempted minimization of the following energy with respect to the parameters Θ and A:
E_{image}(A,Θ)=−∫∫_{R}_{_{M}} log|π_{cos}(I(A( [symbol] (Θ;x)))]dx
−∫∫_{Ω-R}_{_{M}} log|π_{bkg}(I(A( [symbol] (Θ;x)))|dx
where R_{M} denotes the inside of C_{M}. However, the direct calculation of variations involves image gradient and often converges to erroneous solutions due to the discretization of the model domain. In that case, we change the integration domain to the image by implicitly introducing the inverse transformation. A bimodal partition in the image space is now to be recovered. The definition of this domain R_{cor} depends upon the parameters of the transformation |A, Θ| as:
R_{cor}=A( [symbol] (Θ,R_{M})) and y=A( [symbol] (Θ,x))

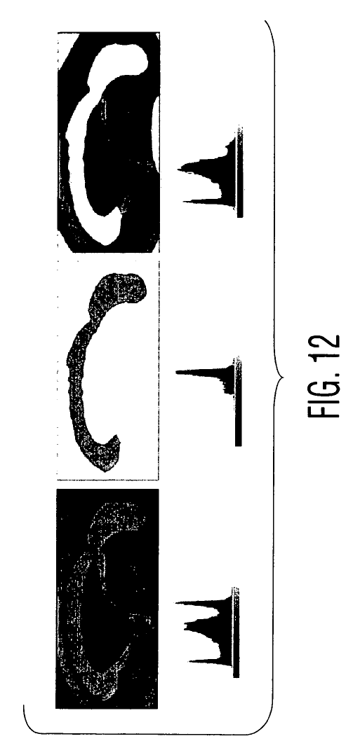

The actual image term of the energy to be minimized then becomes:
E_{image}(A,Θ)=−∫∫_{R}_{_{cor}}log[π_{cor}(I(y))]dy
−∫∫_{Ω-R}_{_{cor}}log [π_{bkg}(I(y))]dy (4)
where statistical independence is considered at the pixel as well as hypotheses level. In practice the distributions of the corpus callosum as well as the ones of the surrounding region [π_{cor}, π_{bkg}] can be recovered in an incremental fashion. In the present case, each distribution is estimated by fitting a mixture of Gaussians to the image histogram using an Expectation-Maximization algorithm (FIG. 12).

The shape based energy term, making use of the non parametric framework introduced earlier is also locally influenced by a covariance matrix of uncertainty calculated on the transformed model. This covariance matrix is computed in a fashion similar to (2) with the difference that it may only account for the linear structure of the transformed model and therefore allow variations of Θ that creates tangential displacements of the contour:

$${Σ}_{Θ}^{- 1} = \frac{1}{β} {∮}_{{C}_{ℳ}} {χ ( x )}^{T} ∇ {\tilde{ϕ}}_{ℳ} ( {x}^{′} ) ∇ {{\tilde{ϕ}}_{ℳ} ( {x}^{′} )}^{T} χ ( x ) ⅆ ( x )$$

where \overline{φ}_{M} is the transformation of φ_{M} under the deformation A( [symbol] (Θ)) Direct computation leads to:

$$∇ {\tilde{ϕ}}_{ℳ} ( {x}^{′} ) = com [ \frac{ⅆ}{ⅆ x} ( ℒ ( Θ , x ) ) ] ∇ {ϕ}_{ℳ} ( x )$$

where “com” denotes the matrix of cofactors. Then we introduce the shape based energy term using the same notations as in (3) as:
Eₛₕₐₚₑ(Θ, Σ_{Θ})=−log(\hat{ƒ}_{H}(Θ, Σ))

The global energy is minimized with respect to the parameters of A and Θ through the computation of variations on E=E_{image}+Eₛₕₐₚₑ and implemented using a standard gradient descent.

We have applied our method to the segmentation of the corpus callosum in MR midsagittal brain slices.

The first step was to build a model of the corpus callosum. Minimization of the registration energy is performed using gradient descent. In parallel, we successively refine the size of the band α around the contour (from 0.3 to 0.05 times the size of the shape), while we increase the complexity of the diffeomorphism (from an affine transformation to an FFD with a regular [7×12] lattice).

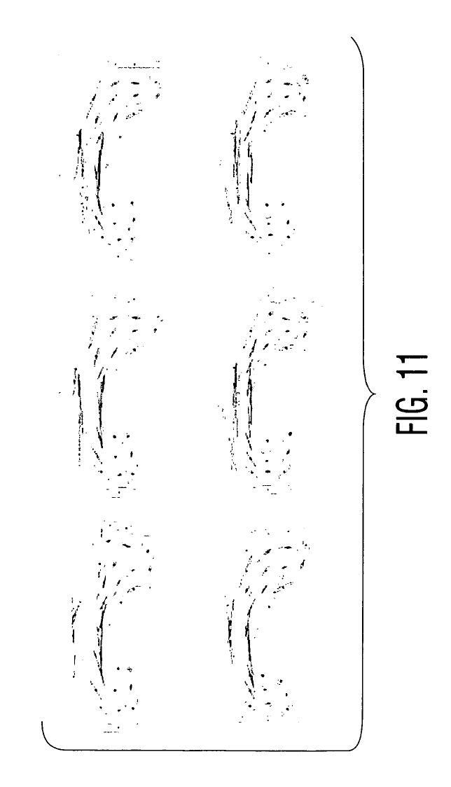

FIG. 11 illustrates that implicit higher order polynomials and registration of corpus callosum with uncertainty estimates. FIG. 11 shows examples of FFD deformations along with uncertainty ellipses. These ellipses are the representation of the 2D conic obtained when projecting the covariance matrix Σ_{Θ} (of size 168×168) on the control points. It therefore does not allow us to represent the correlations between control points.

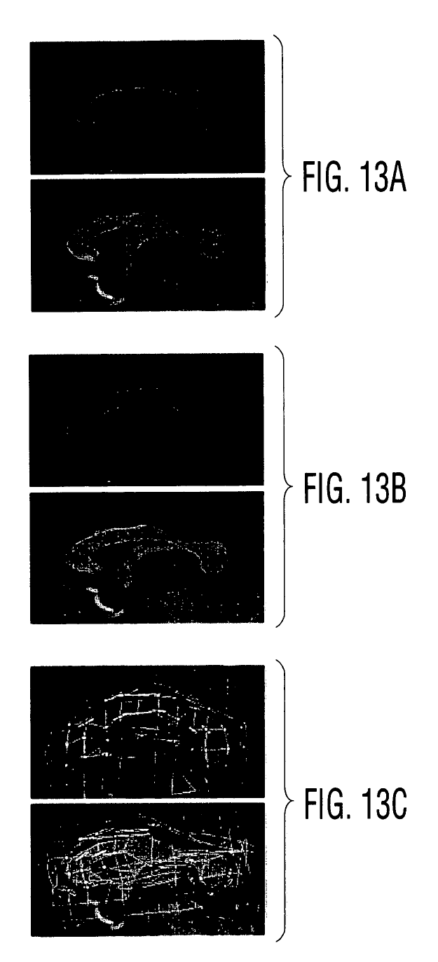

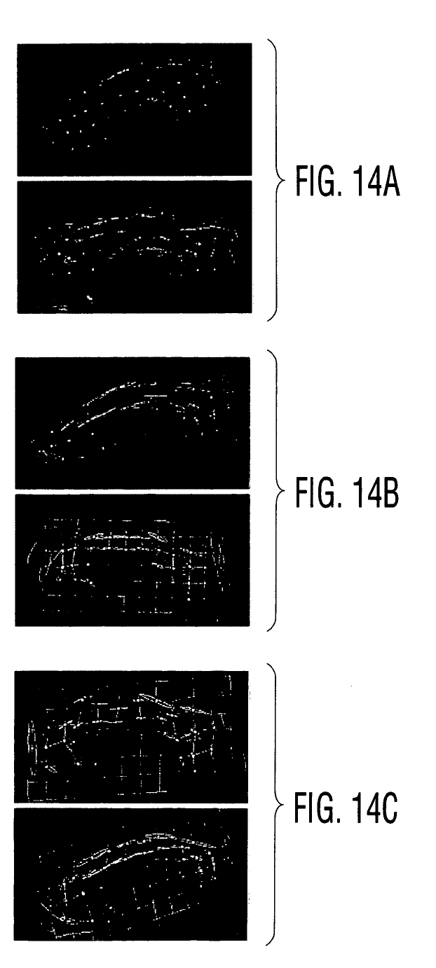

The segmentation process is initialized by positioning the initial contour. Energy minimization is performed through gradient descent, while the PDF π_{cor} and π_{bkg} are estimated by mixtures of Gaussians. FIG. 12 comprises histograms of the corpus callosum and the background area. The use of a Gaussian mixture to model the corpus callosum and background intensity distribution in MR is appropriate. FIG. 12 shows an exemplary histogram of a typical image of the corpus callosum. The figure illustrates how well mixtures of two Gaussian distributions can represent the individual histograms for the corpus callosum and the background, respectively. Segmentation results are presented in FIG. 13A, FIG. 13B, FIG. 13C, and FIG. 14 along with the associated uncertainties. FIG. 13A illustrates a segmentation with uncertainties estimates of the corpus callosum comprising automatic rough positioning of the model. FIG. 13B illustrates a segmentation with uncertainties estimates of the corpus callosum comprising segmentation through affine transformation of the model. FIG. 13C illustrates a segmentation using the local deformation of the FFD grid and uncertainties estimates on the registration/segmentation process. FIG. 13A, FIG. 13B, FIG. 13C demonstrate the individual steps of the segmentation process. FIG. 13A illustrates the automatic initialization of the contour. FIG. 13B illustrates the contour after the affine transformation has been recovered. FIG. 13C illustrates the local deformations. FIG. 14 illustrates an exemplary embodiment of segmentation results with uncertainty measures. FIG. 14 shows additional results and illustrates that the method can handle a wide variety of shapes for the corpus callosum as well as large variations in image contrast. It can be seen that the results in the bottom left image is not perfect. In general, failures may be due to the fact that the shape constraint is not strong enough and the contrast in the image dominates the deformation. Also, it might be that the shape of this particular corpus callosum cannot be captured with the current PDF because it has been reduced to only 10 kernels.

Certain exemplary embodiments comprise a novel method to account for prior knowledge in the segmentation process using non-parametric variable bandwidth kernels that are able to account for errors in the registration and the segmentation process. The method can generate a model of the entity of interest and produce segmentation results.

Certain exemplary embodiments can be extended to higher dimensions. Certain exemplary embodiments can build models in 3D and segmenting entities of large variability. Te covariance matrices of uncertainty Σ_{Θ} can be sparse. Indeed, while using regular FFD, the influence of every grid point is local and therefore many cross correlation coefficients are null. Different types of B-spline deformations using an irregular positioning of control points (but dependent on the model) can address this issue and therefore reduce the dimensionality of the problem. Introduction of uncertainties directly measured in the image as part of the segmentation process can provide local measures of confidence.

Certain exemplary embodiments can determine the energy term E_{image}. We need first to introduce the Heaviside distribution, which we note H and the inverse diffeomorphism of, A∘ [symbol] (Θ) denoted [symbol] (Θ). This diffeomorphism therefore verifies:
A( [symbol] (Θ, [symbol] (Θ,y)))=y (5)

For simpler notation purpose we also pose:
D(x,y)=−H(φ_{M}(x))log(π_{cor}(I(y)))−(1−H(φ_{M}(x)))log(π_{bkg}(I(y)))

Then the image term of the energy (equation 4) can be rewritten as:
E_{image}(Θ)=∫_{Ω}D( [symbol] (Θ,y), y)dy

When differentiating equation (5) with respect to Θ and substituting the expression obtained for d [symbol] /dΘ into the expression of dE_{image}(Θ)/dΘ, we get the following:

$$\frac{ⅆ {E}_{image} ( Θ )}{ⅆ Θ} = - {\int }_{Ω} \frac{\partial D}{\partial {x}^{T}} {( 𝒢 ( Θ , y ) , y ) [ \frac{\partial ( 𝒜 \cdot ℒ )}{\partial {x}^{T}} ( 𝒢 ( Θ , y ) , Θ ) ]}^{- 1} \frac{\partial ( 𝒜 \cdot ℒ )}{\partial {Θ}^{T}} ( 𝒢 ( Θ , y ) , Θ ) ⅆ y$$

Now changing the integration variable according to the diffeomorphism

$$x = 𝒢 ( Θ , y )$$

$$\begin{matrix}\frac{ⅆ {E}_{image} ( Θ )}{ⅆ Θ} = - {\int }_{Ω} \frac{\partial D}{\partial {x}^{T}} ( x , 𝒜 ( ℒ ( Θ , x ) ) ) com \\ {( \frac{\partial ( 𝒜 \cdot ℒ )}{\partial {x}^{T}} ( x , Θ ) )}^{T} \frac{\partial ( 𝒜 \cdot ℒ )}{\partial {Θ}^{T}} ( x , Θ ) ⅆ x\end{matrix}$$

where “com” denotes the matrix of cofactors. When calculating explicitly the partial derivative of D with respect to its first variable, this integral further simplifies into a curve integral along the reference model:

$$\begin{matrix}\frac{ⅆ {E}_{image} ( Θ )}{ⅆ Θ} = - {∮}_{{C}_{ℳ}} \overline{D} ( 𝒜 ( ℒ ( Θ , x ) ) ) \\ {[ com ( \frac{\partial ( 𝒜 \cdot ℒ )}{\partial {x}^{T}} ( x , Θ ) ) \cdot ∇ {ϕ}_{ ℳ} ( x ) ]}^{T} \frac{\partial ( 𝒜 \cdot ℒ )}{\partial {Θ}^{T}} ( x , Θ ) ⅆ x\end{matrix}$$

with \overline{D} defined as:
\overline{D}(y)=−log(π_{cor}(I(y)))+log(π_{bkg}(I(y)))

This expression of the derivative refers only to the contour in the model space. Therefore there is no need to parse the entire image domain at every iteration of the gradient descent used in our implementation. Instead, the model contour can be scanned at every iteration. Parsing of the images is only necessary when we reevaluate the parameters of the Gaussian mixtures for π_{cor} and π_{bkg} (every 20 iterations).

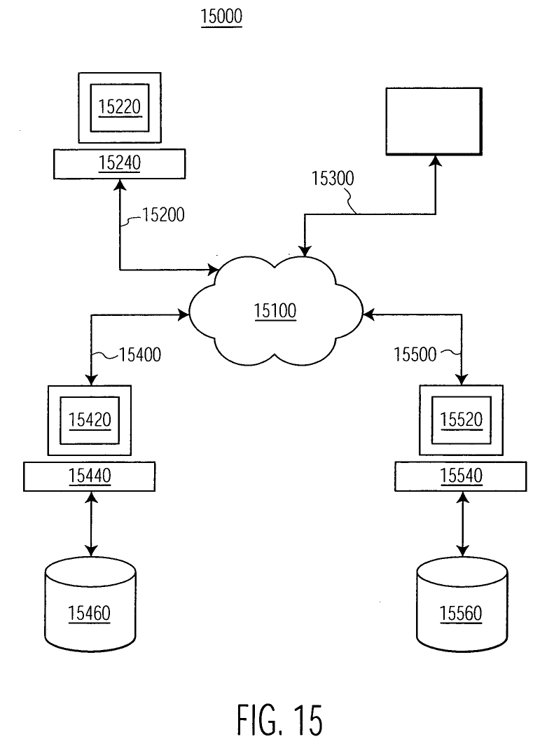

FIG. 15 is a block diagram of an exemplary embodiment of a system 15000, which can comprise a network 15100. Network 15100 can be configured to communicatively couple a plurality of devices, such as an entity generator 15300. Entity generator 15300 can be configured to provide an entity, such as an image of an entity in a representation of two-dimensions or greater. The representation can be a digital representation, which can be transmitted via network 15100 to an information device 15200. For example, entity generator 15300 can be a scanner, MRI device, medical x-ray machine, weather monitoring radar system, fish identifying radar system, digital camera, digital video camera, and/or fax machine, etc. The entity can be, for example, a representation of a human body part, human organ, animal body part, animal organ, computer generated image, photograph, fish, electronic component, human face, emerging tornado, video stream, and/or human handwriting, etc.

Information device 15200 can comprise a user program 15240 and a user interface 15220. User program 15240 can be configured to process the representation obtained from entity generator 15300. For example, user program 15240 can be configured to register the entity and/or determine a probability that the entity belongs to a representation set. User interface 15220 can be configured to render information related to registration and/or a determination of a probability that the entity belongs to the representation set.

System 15000 can comprise a server 15400 and/or a server 15500, which can comprise, respectively, a user program 15440 and a user program 15540. Server 15400 and server 15500 can respectively comprise a user interface 15420 and a user interface 15520. Server 15400 and server 15500 can comprise and/or be communicatively coupled, respectively, to a memory device 15460 and a memory device 15560. In certain exemplary embodiments, server 15400 via user program 15440 can be configured to register the representation obtained from entity generator 15300. Via user interface 15420 a user can view renderings related to the registration of the representation of the entity. Information related to the registration of the representation of the entity can be stored on memory device 15460.

In certain exemplary embodiments, server 15500 via user program 15540 can be configured to determine a vector of parameters and/or a covariance matrix of a representation set that might have a probability of comprising the representation of the entity. In certain exemplary embodiments, server 15500 via user program 15540 can be configured to determine a probability that the representation of the entity belongs to a particular representation set. The user can, via user interface 15520, view information related to the determination of the vector of parameters and/or the covariance matrix of the representation set and/or the probability that the representation of the entity belongs to the particular representation set.

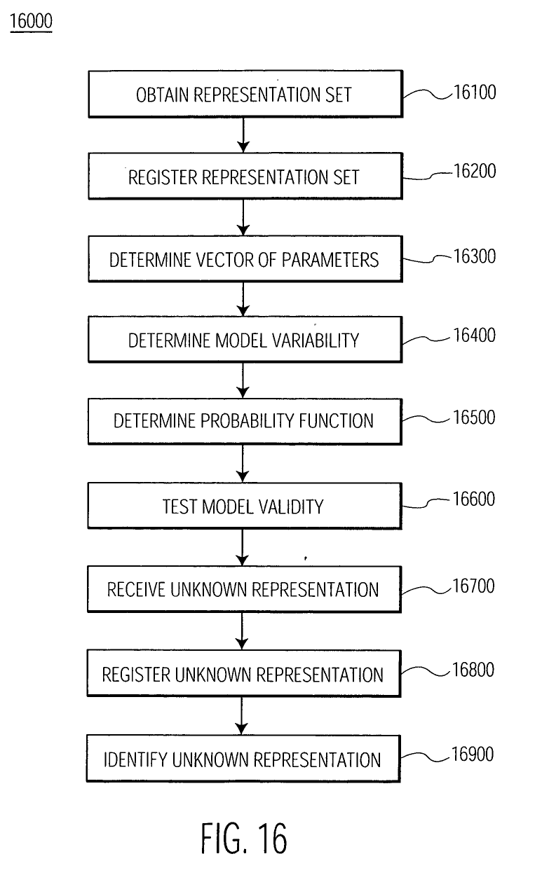

FIG. 16 is a flowchart of an exemplary embodiment of a method 16000. At activity 16100, an exemplary set and/or an exemplary one or more sets of entity representations can be obtained. For example, an entity identification system can be utilized to obtain and/or analyze the one or more sets of entity representations.

At activity 16200, the exemplary set and/or the exemplary plurality of sets of entity representations can be registered. An image can be registered via converting each entity to a single coordinate system. For example, the exemplary plurality of sets of entity representations can be registered via a transformation using free form deformation to match each entity representation to the representation set via energy minimization. In certain exemplary embodiments, each entity can be registered based upon a cubic B-spline. In certain exemplary embodiments, each entity can be registered utilizing a free form deformation model according to a topology preservation algorithm. In certain exemplary embodiments, each entity can be registered via an affine transformation. In certain exemplary embodiments, registration can comprise finding a plurality of transformations for each entity to shapes associated with the representation set. Each of the plurality of transformations can be associated with a weight.

In certain exemplary embodiments, each entity can be registered via minimizing an energy function with a retrieval of a principal mode of a probability density function α exp(E/β)
where:
E is an energy function to be minimized;
α is a selected parameter; and
β is a selected parameter.

In certain exemplary embodiments, each entity can be registered via one or more attempts to optimize an objective function:
E_{α}_{_{∞}}( [symbol] (Θ))+wEₛₘₒₒₜₕ( [symbol] (Θ))]
where:
E is an energy function to be minimized;
[symbol] is a registration transform (L(Theta): R2→R2);
w is a weight factor;
Θ is the vector of parameters; and
   Eₛₘₒₒₜₕ( [symbol] (Θ))=∫∫_{Ω}(| [symbol] ₓₓ|²+2| [symbol] _{xy}|²+| [symbol] _{yy}|²)dΩ
where:
x is a coordinate of a point partially describing the unknown representation;
y is a coordinate of a point partially describing the unknown representation; and
Ω is a domain of an image of the unknown representation.

In certain exemplary embodiments, each entity can be registered via continuously recalculating a distance map associated with each entity responsive to an iterative minimization of an energy function. The energy function can be associated with registration of each entity.

At activity 16300, a plurality of vectors of parameters can be estimated for a particular representation set. The plurality of vectors of parameters can be determined based upon the one or more sets of entity representations, which can be a plurality of exemplary entities corresponding to the representation set. In certain exemplary embodiments, the plurality of vectors of parameters can be associated with a model of the representation set. The model can be warped, for each entity, to a shape associated with the representation set. The model can be constrained in a normal direction. The model can be unconstrained in one or more tangential directions.

In certain exemplary embodiments, the model can be determined via building a statistical estimator via a principal component analysis. In certain exemplary embodiments, the model can be determined via building a statistical estimator via kernels and Parzen Window density estimation.

At activity 16400, a determination can be made regarding variability of the model. For example, a plurality of covariance matrices corresponding to the vector of parameters can be determined. The plurality of covariance matrices can be computed from correspondences at zero isosurfaces and associated with each of said plurality of vectors of parameters. The covariance matrix can be associated with uncertainties of values comprised in the plurality of vectors of parameters. The plurality of covariance matrices can be determined based upon the one or more sets of entity representations, which can be a plurality of exemplary entities corresponding to the representation set.

In certain exemplary embodiments, at least one of the plurality of covariance matrices can be determined via an equation:
Σ_{Θ}=σ²(\hat{χ}^{T}\hat{χ}+γI)⁻¹
where:
Σ_{Θ} is said covariance matrix;
σ² is a scalar, which is a scaling factor for said covariance matrix;
I is an identity matrix;
γ is an arbitrarily small positive parameter; and

$$\hat{χ} = ( \begin{matrix}{η}_{1}^{T} χ ( {x}_{1} ) \\ ⋮ \\ {η}_{K}^{T} χ ( {x}_{K} )\end{matrix} )$$
where:
χ(x₁) is a matrix of dimensionality 2×N based on B-spline basis functions,
with N being a size of ⊖; and
ηᵢ=∇φT(x′ᵢ), a 2×1 column vector of image gradient:
where
∇ is a mathematical gradient;
φ_{T} is a Euclidean distance transform; and
xᵢ is a point coordinate for a particular representation.

At activity 16500, a probability density function associated with the representation set can be determined. The probability density function can be associated with the vector of parameters. The probability density function can be determined responsive to the registration of the plurality of exemplary entities corresponding to the representation set.

At activity 16600, a test can be made regarding model validity. In certain exemplary embodiments, the validity of a model of a set of representations can be tested by determining a log likelihood via evaluating an expression:

$${C}_{K} = {\sum }_{i = 1}^{M} log ( \frac{1}{K} {\sum }_{( {x}_{j} , {Σ}_{j} ) ∈ {ℨ}_{K}} K ( {x}_{j} , {Σ}_{j} , {x}_{i} , {Σ}_{i} ) )$$

where:

C_{K} is a log likelihood;

K is a number of kernels extracted from said representation set;

M is a total number of kernels in said representation set;

xᵢ is an element associated with said representation set; and

Σᵢ is an indexed element from said covariance matrix.

At activity 16700, an unknown representation can be obtained.

At activity 16800, the unknown representation can be registered. For example, the unknown representation can be registered via the transformation using free form deformation to match the unknown representation to the representation set via energy minimization. For example, the unknown representation can be based upon a cubic B-spline. In certain exemplary embodiments, the unknown representation can be registered utilizing a free form deformation model according to a topology preservation algorithm. In certain exemplary embodiments, the unknown representation can be registered via an affine transformation.

In certain exemplary embodiments, the unknown representation can be registered via minimizing an energy function with a retrieval of a principal mode of a probability density function of a form α exp(E/β)
where:
E is an energy function to be minimized;
α is an unknown factor so the density sums to one; and
β is a selected bandwidth scaling parameter.

In certain exemplary embodiments, the unknown representation can be registered via one or more attempts to optimize an objective function:
E_{α}_{_{∞}}( [symbol] (Θ))+wEₛₘₒₒₜₕ( [symbol] (Θ))]
where:
E is a global data-based energy function to be minimized;
[symbol] is a registration transform ( [symbol] (Θ)): R²→R²);
w is a weight factor;
Θ is said vector of parameters; and
   Eₛₘₒₒₜₕ( [symbol] (Θ))=∫∫_{Ω}(| [symbol] ₓₓ|²+2| [symbol] _{xy}|²+| [symbol] _{yy}|²)dΩ
where:
x is a coordinate of a point partially describing said entity;
y is a coordinate of a point partially describing said entity;
[symbol] ₓₓ is a second derivative of registration transform; and
Ω is a domain of an image of said entity.

In certain exemplary embodiments, the unknown representation can be registered via continuously recalculating a distance map associated with each entity responsive to an iterative minimization of an energy function. The energy function can be associated with registration of the unknown representation.

At activity 16900, the unknown representation can be identified and/or a probability can be determined regarding whether the unknown representation should be classified as a member of the representation set. The system can be configured to automatically determine a probability that the entity belongs to a particular representation set. The probability can be based upon one or more of the plurality of covariance matrices and/or the plurality of vectors of parameters. The probability can be based upon and/or responsive to activity 16800. In certain exemplary embodiments, a model of the unknown representation can be warped to a shape associated with the representation set. The model can be constrained in a normal direction. The model can be unconstrained in one or more tangential directions.

Certain exemplary embodiments can comprise an iterative determination of a most likely probability density function associated with the unknown representation. The probability can be determined based upon the most likely probability density function. The probability density function can comprise a subset of one or more kernels selected from a larger set of kernels. In certain exemplary embodiments, a number of kernels associated with the vector of parameters can be reduced via a selection of the subset of kernels from the larger set of kernels via a maximum likelihood criterion.

In certain exemplary embodiments, the probability can be evaluated based upon a hybrid estimator according to an equation:

$${\hat{f}}_{H} ( x , \sum ) = {\sum }_{( {x}_{i} , {\sum }_{i} , {w}_{i} ) ∈ {ℨ}_{K}} {w}_{i} \cdot 𝒦 ( x , \sum , {x}_{i} , {\sum }_{i} )$$

where:
\hat{ƒ}_{H} is said hybrid estimator;
K is a number of kernels extracted from said representation set;
κ is a normal probability density function: N(x−xᵢ(Σ⁺+Σᵢ⁺)⁺)
w is a weight factor;
x is an element associated with said representation set; and
Σ is an indexed element from said covariance matrix.

In certain exemplary embodiments, a user interface can be rendered indicative of the probability that the entity belongs to the particular representation set.

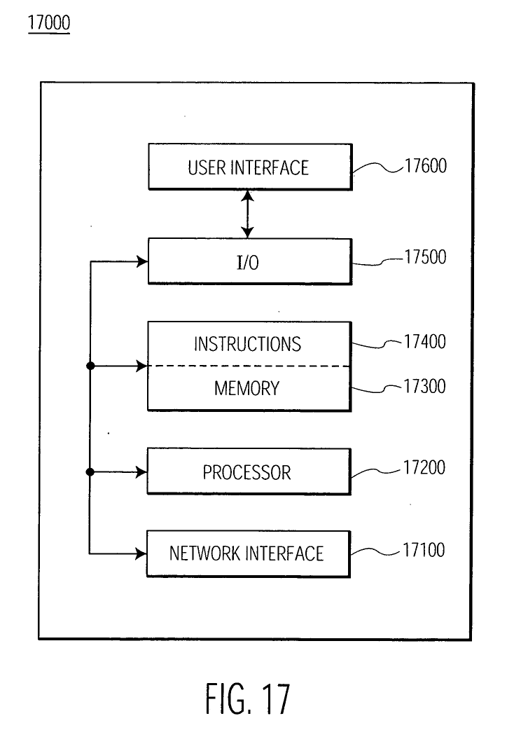

FIG. 17 is a block diagram of an exemplary embodiment of an information device 17000, which in certain operative embodiments can comprise, for example, server 15400, server 15500, and/or user information device 15200 of FIG. 15. Information device 17000 can comprise any of numerous components, such as for example, one or more network interfaces 17 100, one or more processors 17200, one or more memories 17300 containing instructions 17400, one or more input/output (I/O) devices 17500, and/or one or more user interfaces 17600 coupled to I/O device 17500, etc.

In certain exemplary embodiments, via one or more user interfaces 17600, such as a graphical user interface, a user can view a rendering of information related to identifying an entity as a member of a predetermined group.

Still other practical and useful embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application.

Thus, regardless of the content of any portion (e.g., title, field, background, summary, abstract, drawing figure, etc.) of this application, unless clearly specified to the contrary, such as via an explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
any elements can be integrated, segregated, and/or duplicated;
any activity can be repeated, performed by multiple entities, and/or performed in multiple jurisdictions; and
any activity or element can be specifically excluded, the sequence of activities can vary, and/or the interrelationship of elements can vary.

Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. A method comprising a plurality of activities comprising:
providing a system configured to automatically determine a probability that an entity belongs to a representation set, said representation set associated with a plurality of vectors of parameters and a plurality of covariance matrices computed from correspondences at zero isosurfaces and associated with each of said plurality of vectors of parameters, said plurality of covariance matrices associated with uncertainties of registration values comprised in said plurality of vectors of parameters, said probability based upon said plurality of covariance matrices and said plurality of vectors of parameters, said plurality of covariance matrices and said plurality of vectors of parameters determined based upon a plurality of exemplary entities corresponding to said representation set.

2. The method of claim 1, further comprising:
rendering a user interface indicative of said probability.

3. The method of claim 1, further comprising:
determining at least one of said plurality of covariance matrices.

4. The method of claim 1, further comprising:
determining at least one of said plurality of covariance matrices:
Σ_{Θ}=σ²(\hat{χ}^{T}\hat{χ}+γI)⁻¹
where:
Σ_{Θ} is said covariance matrix;
σ² is a scalar, which is a scaling factor for said covariance matrix;
I is an identity matrix;
γ is an arbitrarily small positive parameter; and
$$\hat{χ} = ( \begin{matrix}{η}_{1}^{T} χ ( {x}_{1} ) \\ ⋮ \\ {η}_{K}^{T} χ ( {x}_{K} )\end{matrix} )$$
where:
χ(x₁) is a matrix of dimensionality 2×N based on B-spline basis functions,
with N being a size of Θ; and
ηᵢ=∇φT(x′ᵢ), 2×1 column vector of image gradient:
where
∇ is a mathematical gradient;
φ_{T} is a Euclidean distance transform; and
xᵢ is a point coordinate for a particular representation.

5. The method of claim 1, further comprising:
determining a probability density function associated with said plurality of vectors of parameters, said probability density function determined responsive to a registration of said plurality of exemplary entities corresponding to said representation set.

6. The method of claim 1, further comprising:
registering said entity via a transformation using free form deformation to match said entity to said representation set via energy minimization, said probability based upon said registering activity.

7. The method of claim 1, further comprising:
registering said entity based upon a cubic B-spline, said probability based upon said registering activity.

8. The method of claim 1, further comprising:
registering said entity utilizing a free form deformation model according to a topology preservation algorithm, said probability based upon said registering activity.

9. The method of claim 1, further comprising:
attempting to minimize an energy function with a retrieval of a principal mode of a probability density function of a form α exp(E/β)
where:
E is an energy function to be minimized;
α is an unknown factor so the density sums to one; and
β is a selected bandwidth scaling parameter.

10. The method of claim 1, further comprising:
registering said entity, said probability based upon said registering activity, said entity register via one or more attempts to optimize an objective function:
E_{α}_{_{∞}}( [symbol] (Θ))+wEₛₘₒₒₜₕ( [symbol] (Θ))]
where:
E is a global data-based energy function to be minimized; [symbol]
is a registration transform ( [symbol] (Θ): R²→R²);
w is a weight factor;
Θ is said vector of parameters; and
Eₛₘₒₒₜₕ( [symbol] (Θ))=∫∫_{Ω}(| [symbol] ₓₓ|²+2| [symbol] _{xy}|²+| [symbol] _{yy}|²)dΩ
where:
x is a coordinate of a point partially describing said entity;
y is a coordinate of a point partially describing said entity; [symbol]
ₓₓ is a second derivative of registration transform; and
Ω is a domain of an image of said entity.

11. The method of claim 1, further comprising:
registering said entity, said probability based upon said registering activity; and
continuously recalculating a distance map associated with said entity responsive to an iterative minimization of an energy function, said energy function associated with said registering activity.

12. The method of claim 1, further comprising:
registering each of said plurality of exemplary entities via an affine transformation.

13. The method of claim 1, further comprising:
warping a model of each of said plurality of exemplary entities to a shape of said representation set, said model constrained in a normal direction, said model unconstrained in a tangential direction.

14. The method of claim 1, further comprising:
finding a plurality of transformations for each of said plurality of exemplary entities to shapes of said representation set, each of said plurality of transformations associated with a weight and a covariance matrix of said plurality of covariance matrices.

15. The method of claim 1, further comprising:
evaluating said probability based upon a hybrid estimator according to an equation:
$${\hat{f}}_{H} ( x , \sum ) = {\sum }_{( {x}_{i} , {\sum }_{i} , {w}_{i} ) ∈ {ℨ}_{K}} {w}_{i} \cdot 𝒦 ( x , \sum , {x}_{i} , {\sum }_{i} )$$
where:
\hat{ƒ}H is said hybrid estimator;
K is a number of kernels extracted from said representation set;
κ is a normal probability density function: N(x−xᵢ, (Σ⁺+Σᵢ⁺)⁺)
w is a weight factor;
x is an element associated with said representation set; and
Σ is an indexed element from said covariance matrix.

16. The method of claim 1, further comprising:
determining at least one of said plurality of vectors of parameters.

17. The method of claim 1, further comprising:
iteratively determining a most likely probability density function associated with said entity, said probability based upon said most likely probability density function.

18. The method of claim 1, further comprising:
reducing a number of kernels associated with said vector of parameters via a selection of a subset of kernels from a set of kernels via a maximum likelihood criterion, said probability based upon said subset of kernels.

19. The method of claim 1, further comprising:
via an iterative suboptimal algorithm, reducing a number of kernels associated with said vector of parameters via a selection of a subset of kernels from a set of kernels.

20. The method of claim 1, further comprising:
testing a validity of a model of a set of representations can be tested by determining a log likelihood via evaluating an expression:
$${C}_{K} = {\sum }_{i = 1}^{M} log ( \frac{1}{K} {\sum }_{( {x}_{j} , {\sum }_{j} ) ∈ {ℨ}_{K}} 𝒦 ( {x}_{j} , {\sum }_{j} , {x}_{i} , {\sum }_{i} ) )$$
where:
C_{K} is a log likelihood;
K is a number of kernels extracted from said representation set;
M is a total number of kernels in said representation set;
xᵢ is an element associated with said representation set; and
Σᵢ is an indexed element from said covariance matrix.

21. The method of claim 1, further comprising:
building a statistical estimator via kernels and Parzen Window density estimation, said probability based upon said statistical estimator.

22. A method comprising:
automatically determining a probability that an entity belongs to a representation set, said representation set associated with a plurality of vectors of parameters and a plurality of covariance matrices computed from correspondences at zero isosurfaces and associated with each of said plurality of vectors of parameters, said plurality of covariance matrices associated with uncertainties of registration values comprised in said plurality of vectors of parameters, said probability based upon said plurality of covariance matrices and said plurality of vectors of parameters, said plurality of covariance matrices and said plurality of vectors of parameters determined based upon a plurality of exemplary entities corresponding to said representation set.

23. A machine-readable medium comprising machine instructions for activities comprising:
automatically determining a probability that an entity belongs to a representation set, said representation set associated with a plurality of vectors of parameters and a plurality of covariance matrices computed from correspondences at zero isosurfaces and associated with each of said plurality of vectors of parameters, said plurality of covariance matrices associated with uncertainties of registration values comprised in said plurality of vectors of parameters, said probability based upon said plurality of covariance matrices and said plurality of vectors of parameters, said plurality of covariance matrices and said plurality of vectors of parameters determined based upon a plurality of exemplary entities corresponding to said representation set.

24. A method comprising a plurality of activities comprising:
providing a system configured to automatically determine a probability that an entity belongs to a representation set, said representation set associated with a plurality of vectors of parameters and a plurality of covariance matrices computed from correspondences at zero isosurfaces and associated with each of said plurality of vectors of parameters, said plurality of covariance matrices associated with uncertainties of registration values comprised in said plurality of vectors of parameters, said probability based upon said plurality of covariance matrices and said plurality of vectors of parameters, said plurality of covariance matrices and said plurality of vectors of parameters determined based upon a plurality of exemplary entities corresponding to said representation set; and
a means for causing a user interface to be rendered, the user interface indicative of said probability.
